(19) United States
(12) Patent Application Publication
(10) Pub. No.: US 2026/0094039 A1
(43) Pub. Date: Apr. 2, 2026

(54) Quantum Computer Clusters for Large-Scale Applications

(71) Applicant: Rigetti & Co. LLC, Berkeley, CA (US)

(72) Inventors: Chad Tyler RIGETTI, Walnut Creek, CA (US); Glenn JONES, Berkeley, CA (US)

(73) Assignee: Rigetti & Co. LLC, Berkeley, CA (US)

(21) Appl. No.: 18/888,491

(22) Filed: Sep. 18, 2024

Related U.S. Application Data
(63) Continuation of application No. PCT/US2023/016126, filed on Mar. 23, 2023.
(60) Provisional application No. 63/322,967, filed on Mar. 23, 2022.
(60) Provisional application No. 63/354,145, filed on Jun. 21, 2022.

(51) Int. Cl. G06N 10/40; G06N 10/20

(52) U.S. Cl. CPC G06N 10/40; G06N 10/20

(57) ABSTRACT

In a general aspect, quantum computer clusters are configured for large-scale applications. In some implementations, a quantum computer cluster includes a global controller, a first quantum computer system including a first qubit device, and a second quantum computer system including a second qubit device. Each of the first and second quantum computer systems are communicably connected to the global controller. The first and second quantum computer systems include respective quantum processing units housed in distinct cryostats. Operating the global controller includes obtaining respective local frames from the first and second quantum computer systems; determining respective values of phase compensation for the quantum computer systems based on the respective local frames; transmitting the respective values of the phase compensation to the quantum computer systems; and causing the quantum computer systems to apply phase shifts to phases of control signals.

### CROSS-REFERENCE TO RELATED APPLICATIONS

This application claims priority to U.S. Provisional Patent Application No. 63/322,967, filed Mar. 23, 2022, entitled “Modular Quantum Computer Architecture for Large-scale Applications;” and to U.S. Provisional Patent Application No. 63/354,145, filed Jun. 21, 2022, entitled “Modular Quantum Computer Architecture for Large-scale Applications.” The above-referenced priority documents are incorporated herein by reference.

### TECHNICAL FIELD

The following description relates to formation and operation of quantum computer clusters for large-scale applications.

### BACKGROUND

Quantum computers can perform computational tasks by storing and processing information within quantum states of quantum systems. For example, qubits (i.e., quantum bits) can be stored in and represented by an effective two-level sub-manifold of a quantum coherent physical system. A variety of physical systems have been proposed for quantum computing applications. Examples include superconducting circuits, trapped ions, spin systems and others.

### BRIEF DESCRIPTION OF THE DRAWINGS

FIG. 1 is a block diagram of an example computing environment.

FIG. 2A is a schematic diagram showing aspects of an example quantum computer cluster.

FIG. 2B is a block diagram showing aspects of the example quantum computer system in the example quantum computer cluster in FIG. 2A.

FIG. 2C is a block diagram showing a perspective view of the example modular quantum processing unit shown in FIG. 2B.

FIG. 3A is a schematic diagram showing aspects of an example quantum computer cluster.

FIG. 3B is a flow chart showing aspects of an example process for maintaining phase coherence of control signals in distinct quantum computer systems in a quantum computer cluster.

FIG. 4A is a schematic diagram of an example quantum computer cluster.

FIG. 4B is a schematic diagram of the quantum computer system in the example quantum computer cluster shown in FIG. 4A.

FIG. 4C is a schematic diagram of an example quantum processing unit shown in FIG. 4A.

FIG. 5 is a schematic diagram showing aspects of an example quantum computer cluster.

FIG. 6A is a schematic diagram showing aspects of an example quantum computer cluster.

FIG. 6B is a schematic diagram showing aspects of an example quantum computer cluster.

FIG. 6C is a schematic diagram showing aspects of an example quantum computer cluster.

FIG. 7 is a flow chart showing aspects of an example process for conditioning control signals communicated to a quantum processing unit in a quantum computer system.

FIGS. 8A-8F are schematic diagrams showing aspects of quantum computer clusters with quantum computer systems coherently interconnected in various topologies.

### DETAILED DESCRIPTION

In some aspects of what is described here, a quantum computer cluster (e.g., including as many as 1,000,000 qubits or more) includes multiple interconnected quantum computer systems. In some implementations, a quantum computer cluster includes multiple quantum computer systems with respective quantum processing units housed in distinct cryostats. In some instances, the quantum processing units of the respective quantum computer systems are coherently interconnected with one another via respective coherent interlinks for creating entanglement between qubit devices in distinct quantum computer systems. In some instances, the quantum computer systems are also communicably connected to a global controller of the quantum computer cluster, which may be configured to communicate with local control systems of the respective quantum computer system, for example, to determine local frames and phase compensation values for control signals communicated in the respective quantum computer systems.

In some implementations, a local control system of a quantum computer system in the quantum computer cluster may include a separate control chip configured to condition a digital pulse waveform prior to passing the digital pulse waveform to a quantum processing unit in the quantum computer system. For example, the control chip may include modules or components that are configured to obtain a digital pulse waveform; up-sample the digital pulse waveform to increase its sample rate; pulse-shape the up-sampled digital pulse waveform; convert the conditioned digital pulse waveform to an analog pulse waveform; filter the analog pulse waveform; and communicate the filtered analog pulse waveform to the quantum processing unit. In some instances, the digital pulse waveform may be generated, by operation of the local control system, with a phase correction determined by and received from the global controller.

In some implementations, the systems and techniques described here can provide technical advantages and improvements. For example, the systems and techniques presented here may allow the use of distinct and remote qubit devices (e.g., qubit devices in distinct cryostats) to execute a multi-qubit quantum logic gate in a quantum compute program; to create entanglement between the distinct and remote qubit devices; and to maintain coherence in control signals in distinct quantum computer systems in the quantum computer cluster. The systems and techniques presented here can provide improved performance, including computational power, error correction, scalability, and accuracy. The methods and systems presented here may provide a large number of control signals on a single control chip which can reduce bandwidth and may simplify data exchange and improve data communication efficiency between a qubit control sequencer and the quantum processing unit. In some cases, a combination of these and potentially other advantages and improvements may be obtained.

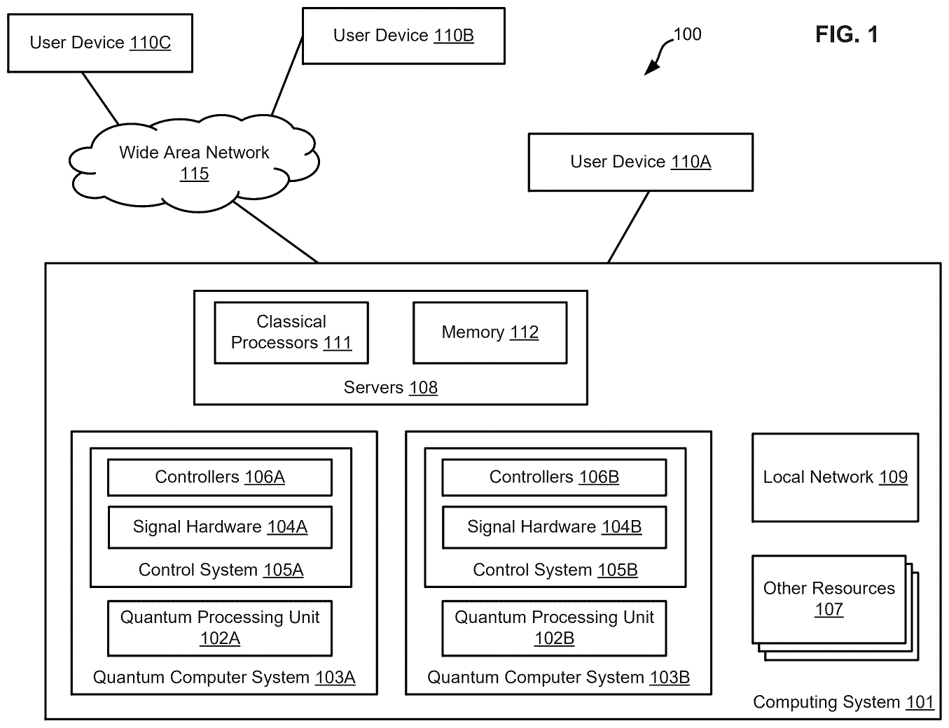

FIG. 1 is a block diagram of an example computing environment 100. The example computing environment 100 shown in FIG. 1 includes a computing system 101 and user devices 110A, 110B, 110C. A computing environment may include additional or different features, and the components of a computing environment may operate as described with respect to FIG. 1 or in another manner.

The example computing system 101 includes classical and quantum computing resources and exposes their functionality to the user devices 110A, 110B, 110C (referred to collectively as “user devices 110”). The computing system 101 shown in FIG. 1 includes one or more servers 108, quantum computing systems 103A, 103B, a local network 109, and other resources 107. In some instances, the computing system 101 may include a quantum computer cluster that includes the quantum computing systems 103A, 103B. The computing system 101 may also include one or more user devices (e.g., the user device 110A) as well as other features and components. A computing system may include additional or different features, and the components of a computing system may operate as described with respect to FIG. 1 or in another manner.

The example computing system 101 can provide services to the user devices 110, for example, as a cloud-based or remote-accessed computer system, as a distributed computing resource, as a supercomputer or another type of high-performance computing resource, or in another manner. The computing system 101 or the user devices 110 may also have access to one or more other quantum computing systems (e.g., quantum computing resources that are accessible through the wide area network 115, the local network 109 or otherwise).

The user devices 110 shown in FIG. 1 may include one or more classical processors, memory, user interfaces, communication interfaces, and other components. For instance, the user devices 110 may be implemented as laptop computers, desktop computers, smartphones, tablets or other types of computer devices. In the example shown in FIG. 1, to access computing resources of the computing system 101, the user devices 110 send information (e.g., programs, instructions, commands, requests, input data, etc.) to the servers 108; and in response, the user devices 110 receive information (e.g., application data, output data, prompts, alerts, notifications, results, etc.) from the servers 108. The user devices 110 may access services of the computing system 101 in another manner, and the computing system 101 may expose computing resources in another manner.

In the example shown in FIG. 1, the local user device 110A operates in a local environment with the servers 108 and other elements of the computing system 101. For instance, the user device 110A may be co-located with (e.g., located within 0.5 to 1 km of) the servers 108 and possibly other elements of the computing system 101. As shown in FIG. 1, the user device 110A communicates with the servers 108 through a local data connection.

The local data connection in FIG. 1 is provided by the local network 109. For example, some or all of the servers 108, the user device 110A, the quantum computing systems 103A, 103B and the other resources 107 may communicate with each other through the local network 109. In some implementations, the local network 109 operates as a communication channel that provides one or more low-latency communication pathways from the server 108 to the quantum computer systems 103A, 103B (or to one or more of the elements of the quantum computer systems 103A, 103B). The local network 109 can be implemented, for instance, as a wired or wireless Local Area Network, an Ethernet connection, or another type of wired or wireless connection. The local network 109 may include one or more wired or wireless routers, wireless access points (WAPs), wireless mesh nodes, switches, high-speed cables, or a combination of these and other types of local network hardware elements. In some cases, the local network 109 includes a software-defined network that provides communication among virtual resources, for example, among an array of virtual machines operating on the server 108 and possibly elsewhere.

In the example shown in FIG. 1, the remote user devices 110B, 110C operate remotely from the servers 108 and other elements of the computing system 101. For instance, the user devices 110B, 110C may be located at a remote distance (e.g., more than 1 km, 10 km, 100 km, 1,000 km, 10,000 km, or farther) from the servers 108 and possibly other elements of the computing system 101. As shown in FIG. 1, each of the user devices 110B, 110C communicates with the servers 108 through a remote data connection.

The remote data connection in FIG. 1 is provided by a wide area network 115, which may include, for example, the Internet or another type of wide area communication network. In some cases, remote user devices use another type of remote data connection (e.g., satellite-based connections, a cellular network, a virtual private network, etc.) to access the servers 108. The wide area network 115 may include one or more internet servers, firewalls, service hubs, base stations, or a combination of these and other types of remote networking elements. Generally, the computing environment 100 can be accessible to any number of remote user devices.

The example servers 108 shown in FIG. 1 can manage interaction with the user devices 110 and utilization of the quantum and classical computing resources in the computing system 101. For example, based on information from the user devices 110, the servers 108 may delegate computational tasks to the quantum computing systems 103A, 103B and the other resources 107; the servers 108 can then send information to the user devices 110 based on output data from the computational tasks performed by the quantum computing systems 103A, 103B and the other resources 107.

As shown in FIG. 1, the servers 108 are classical computing resources that include classical processors 111 and memory 112. The servers 108 may also include one or more communication interfaces that allow the servers to communicate via the local network 109, the wide area network 115 and possibly other channels. In some implementations, the servers 108 may include a host server, an application server, a virtual server or a combination of these and other types of servers. The servers 108 may include additional or different features, and may operate as described with respect to FIG. 1 or in another manner.

The classical processors 111 can include various kinds of apparatus, devices, and machines for processing data, including, by way of example, a microprocessor, a central processing unit (CPU), a graphics processing unit (GPU), an FPGA (field programmable gate array), an ASIC (application specific integrated circuit), or combinations of these. The memory 112 can include, for example, a random-access memory (RAM), a storage device (e.g., a writable read-only memory (ROM) or others), a hard disk, or another type of storage medium. The memory 112 can include various forms of volatile or non-volatile memory, media and memory devices, etc.

Each of the example quantum computing systems 103A, 103B operates as a quantum computing resource in the computing system 101. The other resources 107 may include additional quantum computing resources (e.g., quantum computing systems, quantum virtual machines (QVMs) or quantum simulators) as well as classical (non-quantum) computing resources such as, for example, digital microprocessors, specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), etc., or combinations of these and other types of computing modules.

In some implementations, the servers 108 generate programs, identify appropriate computing resources (e.g., a QPU or QVM) in the computing system 101 to execute the programs, and send the programs to the identified resources for execution. For example, the servers 108 may send programs to the quantum computing system 103A, the quantum computing system 103B or any of the other resources 107. The programs may include classical programs, quantum programs, hybrid classical/quantum programs, and may include any type of function, code, data, instruction set, etc.

In some instances, programs can be formatted as source code that can be rendered in human-readable form (e.g., as text) and can be compiled, for example, by a compiler running on the servers 108, on the quantum computing systems 103, or elsewhere. In some instances, programs can be formatted as compiled code, such as, for example, binary code (e.g., machine-level instructions) that can be executed directly by a computing resource. Each program may include instructions corresponding to computational tasks that, when performed by an appropriate computing resource, generate output data based on input data. For example, a program can include instructions formatted for a quantum computer system, a quantum virtual machine, a digital microprocessor, co-processor or other classical data processing apparatus, or another type of computing resource.

In some cases, a program may be expressed in a hardware-independent format. For example, quantum machine instructions may be provided in a quantum instruction language such as Quil, described in the publication “A Practical Quantum Instruction Set Architecture,” arXiv:1608.03355v2, dated Feb. 17, 2017, or another quantum instruction language. For instance, the quantum machine instructions may be written in a format that can be executed by a broad range of quantum processing units or quantum virtual machines. In some cases, a program may be expressed in high-level terms of quantum logic gates or quantum algorithms, in lower-level terms of fundamental qubit rotations and controlled rotations, or in another form. In some cases, a program may be expressed in terms of control signals (e.g., pulse sequences, delays, etc.) and parameters for the control signals (e.g., frequencies, phases, durations, channels, etc.). In some cases, a program may be expressed in another form or format.

In some implementations, the servers 108 include one or more compilers that convert programs between formats. For example, the servers 108 may include a compiler that converts hardware-independent instructions to binary programs for execution by the quantum computing systems 103A, 103B. In some cases, a compiler can compile a program to a format that targets a specific quantum resource in the computer system 101. For example, a compiler may generate a different binary program (e.g., from the same source code) depending on whether the program is to be executed by the quantum computing system 103A or the quantum computing system 103B.

In some cases, a compiler generates a partial binary program that can be updated, for example, based on specific parameters. For instance, if a quantum program is to be executed iteratively on a quantum computing system with varying parameters on each iteration, the compiler may generate the binary program in a format that can be updated with specific parameter values at runtime (e.g., based on feedback from a prior iteration, or otherwise). In some cases, a compiler generates a full binary program that does not need to be updated or otherwise modified for execution.

In some implementations, the servers 108 generate a schedule for executing programs, allocate computing resources in the computing system 101 according to the schedule, and delegate the programs to the allocated computing resources. The servers 108 can receive, from each computing resource, output data from the execution of each program. Based on the output data, the servers 108 may generate additional programs that are then added to the schedule, output data that is provided back to a user device 110, or perform another type of action.

In some implementations, all or part of the computing environment operates as a cloud-based quantum computing (QC) environment, and the servers 108 operate as a host system for the cloud-based QC environment. The cloud-based QC environment may include software elements that operate on both the user devices 110 and the computer system 101 and interact with each other over the wide area network 115. For example, the cloud-based QC environment may provide a remote user interface, for example, through a browser or another type of application on the user devices 110. The remote user interface may include, for example, a graphical user interface or another type of user interface that obtains input provided by a user of the cloud-based QC environment. In some cases, the remote user interface includes, or has access to, one or more application programming interfaces (APIs), command line interfaces, graphical user interfaces, or other elements that expose the services of the computer system 101 to the user devices 110.

In some cases, the cloud-based QC environment may be deployed in a “serverless” computing architecture. For instance, the cloud-based QC environment may provide on-demand access to a shared pool of configurable computing resources (e.g., networks, servers, storage, applications, services, quantum computing resources, classical computing resources, etc.) that can be provisioned for requests from user devices 110. Moreover, the cloud-based computing systems 104 may include or utilize other types of computing resources, such as, for example, edge computing, fog computing, etc.

In an example implementation of a cloud-based QC environment, the servers 108 may operate as a cloud provider that dynamically manages the allocation and provisioning of physical computing resources (e.g., GPUs, CPUs, QPUs, etc.). Accordingly, the servers 108 may provide services by defining virtualized resources for each user account. For instance, the virtualized resources may be formatted as virtual machine images, virtual machines, containers, or virtualized resources that can be provisioned for a user account and configured by a user. In some cases, the cloud-based QC environment is implemented using a resource such as, for example, OPENSTACK®. OPENSTACK® is an example of a software platform for cloud-based computing, which can be used to provide virtual servers and other virtual computing resources for users.

In some cases, the server 108 stores quantum machine images (QMI) for each user account. A quantum machine image may operate as a virtual computing resource for users of the cloud-based QC environment. For example, a QMI can provide a virtualized development and execution environment to develop and run programs (e.g., quantum programs or hybrid classical/quantum programs). When a QMI operates on the server 108, the QMI may engage either of the quantum processor units 102A, 102B, and interact with a remote user device (110B or 110C) to provide a user programming environment. The QMI may operate in close physical proximity to and have a low-latency communication link with the quantum computing systems 103A, 103B. In some implementations, remote user devices connect with QMIs operating on the servers 108 through secure shell (SSH) or other protocols over the wide area network 115.

In some implementations, all or part of the computing system 101 operates as a hybrid computing environment. For example, quantum programs can be formatted as hybrid classical/quantum programs that include instructions for execution by one or more quantum computing resources and instructions for execution by one or more classical resources. The servers 108 can allocate quantum and classical computing resources in the hybrid computing environment, and delegate programs to the allocated computing resources for execution. The quantum computing resources in the hybrid environment may include, for example, one or more quantum processing units (QPUs), one or more quantum virtual machines (QVMs), one or more quantum simulators, or possibly other types of quantum resources. The classical computing resources in the hybrid environment may include, for example, one or more digital microprocessors, one or more specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), or other types of computing modules.

In some cases, the servers 108 can select the type of computing resource (e.g., quantum or classical) to execute an individual program, or part of a program, in the computing system 101. For example, the servers 108 may select a particular quantum processing unit (QPU) or other computing resource based on availability of the resource, speed of the resource, information or state capacity of the resource, a performance metric (e.g., process fidelity) of the resource, or based on a combination of these and other factors. In some cases, the servers 108 can perform load balancing, resource testing and calibration, and other types of operations to improve or optimize computing performance.

Each of the example quantum computing systems 103A, 103B shown in FIG. 1 can perform quantum computational tasks by executing quantum machine instructions (e.g., a binary program compiled for the quantum computing system). In some implementations, a quantum computing system can perform quantum computation by storing and manipulating information within quantum states of a composite quantum system. For example, qubits (i.e., quantum bits) can be stored in and represented by an effective two-level sub-manifold of a quantum coherent physical system. In some instances, quantum logic can be executed in a manner that allows large-scale entanglement within the quantum system. Control signals can manipulate the quantum states of individual qubits and the joint states of multiple qubits. In some instances, information can be read out from the composite quantum system by measuring the quantum states of the qubits. In some implementations, the quantum states of the qubits are read out by measuring the transmitted or reflected signal from auxiliary quantum devices that are coupled to individual qubits.

In some implementations, a quantum computing system can operate using gate-based models for quantum computing. For example, the qubits can be initialized in an initial state, and a quantum logic circuit comprised of a series of quantum logic gates can be applied to transform the qubits and extract measurements representing the output of the quantum computation. Individual qubits may be controlled by single-qubit quantum logic gates, and pairs of qubits may be controlled by two-qubit quantum logic gates (e.g., entangling gates that are capable of generating entanglement between the pair of qubits). In some implementations, a quantum computing system can operate using adiabatic or annealing models for quantum computing. For instance, the qubits can be initialized in an initial state, and the controlling Hamiltonian can be transformed adiabatically by adjusting control parameters to another state that can be measured to obtain an output of the quantum computation.

In some models, fault-tolerance can be achieved by applying a set of high-fidelity control and measurement operations to the qubits. For example, quantum error correcting schemes can be deployed to achieve fault-tolerant quantum computation. Other computational regimes may be used; for example, quantum computing systems may operate in non-fault-tolerant regimes. In some implementations, a quantum computing system is constructed and operated according to a scalable quantum computing architecture. For example, in some cases, the architecture can be scaled to a large number of qubits to achieve large-scale general purpose coherent quantum computing. Other architectures may be used; for example, quantum computing systems may operate in small-scale or non-scalable architectures.

The example quantum computing system 103A shown in FIG. 1 includes a quantum processing unit 102A and a control system 105A, which controls the operation of the quantum processing unit 102A. Similarly, the example quantum computing system 103B includes a quantum processing unit 102B and a control system 105B, which controls the operation of a quantum processing unit 102B. A quantum computing system may include additional or different features, and the components of a quantum computing system may operate as described with respect to FIG. 1 or in another manner.

In some instances, all or part of the quantum processing unit 102A functions as a quantum processor, a quantum memory, or another type of subsystem. In some examples, the quantum processing unit 102A includes a quantum circuit system. The quantum circuit system may include qubit devices, readout devices and possibly other devices that are used to store and process quantum information. In some cases, the quantum processing unit 102A includes a superconducting circuit, and the qubit devices are implemented as circuit devices that include Josephson junctions, for example, in superconducting quantum interference device (SQUID) loops or other arrangements, and are controlled by radio-frequency signals, microwave signals, and bias signals delivered to the quantum processing unit 102A. In some cases, the quantum processing unit 102A includes an ion trap system, and the qubit devices are implemented as trapped ions controlled by optical signals delivered to the quantum processing unit 102A. In some cases, the quantum processing unit 102A includes a spin system, and the qubit devices are implemented as nuclear, or electron spins controlled by microwave or radio-frequency signals delivered to the quantum processing unit 102A. The quantum processing unit 102A may be implemented based on another physical modality of quantum computing.

The quantum processing unit 102A may include, or may be deployed within, a controlled environment. The controlled environment can be provided, for example, by shielding equipment, cryogenic equipment, and other types of environmental control systems. In some examples, the components in the quantum processing unit 102A operate in a cryogenic temperature regime and are subject to very low electromagnetic and thermal noise. For example, magnetic shielding can be used to shield the system components from stray magnetic fields, optical shielding can be used to shield the system components from optical noise, thermal shielding and cryogenic equipment can be used to maintain the system components at controlled temperature, etc.

In some implementations, the example quantum processing unit 102A can process quantum information by applying control signals to the qubits in the quantum processing unit 102A. The control signals can be configured to encode information in the qubits, to process the information by performing quantum logic gates or other types of operations, or to extract information from the qubits. In some examples, the operations can be expressed as single-qubit quantum logic gates, two-qubit quantum logic gates, or other types of quantum logic gates that operate on one or more qubits. A quantum logic circuit, which includes a sequence of quantum logic operations, can be applied to the qubits to perform a quantum algorithm. The quantum algorithm may correspond to a computational task, a hardware test, a quantum error correction procedure, a quantum state distillation procedure, or a combination of these and other types of operations.

In some implementations, the example quantum processing unit 102 is a modular quantum processing unit that includes multiple quantum processor modules. For example, the quantum processing unit 102 may include a two-dimensional or three-dimensional array of quantum processor modules, and each quantum processor module may include an array of quantum circuit devices. In some cases, the quantum processor modules are supported on a common substrate, and they are interconnected through circuitry (e.g., superconducting circuitry) on the common substrate.

In some instances, each of the quantum processor modules can include a superconducting quantum circuit that includes one or more quantum circuit devices and superconductive lines that connect the one or more quantum circuit devices. For instance, each quantum processor module may include qubit devices, readout resonator devices, tunable-frequency coupler devices, capacitive coupler devices, or other quantum circuit devices. Each quantum processor module may include flux bias control lines, microwave drive lines, readout signal lines, or other types of control lines for providing control signals to respective quantum circuit devices. In some implementations, quantum processor modules can be coupled to each other by inter-chip coupler devices in one or more cap structures.

In some implementations, a cap structure and a quantum processor module in a modular quantum processing unit 102A are bonded together, for example, by bonding bumps or another type of bond. In some instances, the cap structure contains one or more recesses, each defined by a recessed surface and sidewalls. When a cap structure and a quantum processor module are bonded together, a recess on the cap structure can house a qubit device on the quantum processor module. The cap structure may also contain various superconducting circuitry. Circuitry may include a variety of superconducting circuit elements to control or readout quantum circuit devices (e.g., qubit devices). For instance, circuitry on a cap structure may include coupling lines, microwave drive lines, microwave feedlines, flux bias lines, tunable-frequency coupler devices, or other circuit elements. In some instances, a cap structure may be communicably coupled to the control system 105, e.g., to receive control signals or transmit readout signals.

The example control system 105A includes controllers 106A and signal hardware 104A. Similarly, control system 105B includes controllers 106B and signal hardware 104B. All or part of the control systems 105A, 105B can operate in a room-temperature environment or another type of environment, which may be located near the respective quantum processing units 102A, 102B. In some cases, the control systems 105A, 105B include classical computers, signaling equipment (microwave, radio, optical, bias, etc.), electronic systems, vacuum control systems, refrigerant control systems or other types of control systems that support operation of the quantum processing units 102A, 102B.

The control systems 105A, 105B may be implemented as distinct systems that operate independent of each other. In some cases, the control systems 105A, 105B may include one or more shared elements; for example, the control systems 105A, 105B may operate as a single control system that operates both quantum processing units 102A, 102B. Moreover, a single quantum computer system may include multiple quantum processing units, which may operate in the same controlled (e.g., cryogenic) environment or in separate environments.

The example signal hardware 104A includes components that communicate with the quantum processing unit 102A. The signal hardware 104A may include, for example, waveform generators, amplifiers, digitizers, high-frequency sources, DC sources, AC sources, etc. The signal hardware may include additional or different features and components. In the example shown, components of the signal hardware 104A are adapted to interact with the quantum processing unit 102A. For example, the signal hardware 104A can be configured to operate in a particular frequency range, configured to generate and process signals in a particular format, or the hardware may be adapted in another manner.

In some instances, one or more components of the signal hardware 104A generate control signals, for example, based on control information from the controllers 106A. The control signals can be delivered to the quantum processing unit 102A during operation of the quantum computing system 103A. For instance, the signal hardware 104A may generate signals to implement quantum logic operations, readout operations or other types of operations. As an example, the signal hardware 104A may include arbitrary waveform generators (AWGs) that generate electromagnetic waveforms (e.g., microwave or radiofrequency) or laser systems that generate optical waveforms. The waveforms or other types of signals generated by the signal hardware 104A can be delivered to devices in the quantum processing unit 102A to operate qubit devices, readout devices, bias devices, coupler devices or other types of components in the quantum processing unit 102A.

In some instances, the signal hardware 104A receives and processes signals from the quantum processing unit 102A. The received signals can be generated by the execution of a quantum program on the quantum computing system 103A. For instance, the signal hardware 104A may receive signals from the devices in the quantum processing unit 102A in response to readout or other operations performed by the quantum processing unit 102A. Signals received from the quantum processing unit 102A can be mixed, digitized, filtered, or otherwise processed by the signal hardware 104A to extract information, and the information extracted can be provided to the controllers 106A or handled in another manner. In some examples, the signal hardware 104A may include a digitizer that digitizes electromagnetic waveforms (e.g., microwave or radiofrequency) or optical signals, and a digitized waveform can be delivered to the controllers 106A or to other signal hardware components. In some instances, the controllers 106A process the information from the signal hardware 104A and provide feedback to the signal hardware 104A; based on the feedback, the signal hardware 104A can in turn generate new control signals that are delivered to the quantum processing unit 102A.

In some implementations, the signal hardware 104A includes signal delivery hardware that interfaces with the quantum processing unit 102A. For example, the signal hardware 104A may include filters, attenuators, directional couplers, multiplexers, diplexers, bias components, signal channels, isolators, amplifiers, power dividers and other types of components. In some instances, the signal delivery hardware performs preprocessing, signal conditioning, or other operations to the control signals to be delivered to the quantum processing unit 102A. In some instances, signal delivery hardware performs preprocessing, signal conditioning or other operations on readout signals received from the quantum processing unit 102A.

The example controllers 106A communicate with the signal hardware 104A to control operations of the quantum computing system 103A. The controllers 106A may include classical computing hardware that directly interfaces with components of the signal hardware 104A. The example controllers 106A may include classical processors, memory, clocks, digital circuitry, analog circuitry, and other types of systems or subsystems. The classical processors may include one or more single- or multi-core microprocessors, digital electronic controllers, special purpose logic circuitry, e.g., an FPGA (field programmable gate array) or an ASIC (application specific integrated circuit), or other types of data processing apparatus. The memory may include any type of volatile or non-volatile memory or another type of computer storage medium. The controllers 106A may also include one or more communication interfaces that allow the controllers 106A to communicate via the local network 109 and possibly other channels. The controllers 106A may include additional or different features and components.

In some implementations, the controllers 106A include memory or other components that store quantum state information, for example, based on qubit readout operations performed by the quantum computing system 103A. For instance, the states of one or more qubits in the quantum processing unit 102A can be measured by qubit readout operations, and the measured state information can be stored in a cache or other type of memory system in or more of the controllers 106A. In some cases, the measured state information is subsequently used in the execution of a quantum program, a quantum error correction procedure, a quantum processing unit (QPU) calibration or testing procedure, or another type of quantum process.

In some implementations, the controllers 106A include memory or other components that store a quantum program containing quantum machine instructions for execution by the quantum computing system 103A. In some instances, the controllers 106A can interpret the quantum machine instructions and perform hardware-specific control operations according to the quantum machine instructions. For example, the controllers 106A may cause the signal hardware 104A to generate control signals that are delivered to the quantum processing unit 102A to execute the quantum machine instructions.

In some instances, the controllers 106A extract qubit state information from qubit readout signals, for example, to identify the quantum states of qubits in the quantum processing unit 102A or for other purposes. For example, the controllers may receive the qubit readout signals (e.g., in the form of analog waveforms) from the signal hardware 104A, digitize the qubit readout signals, and extract qubit state information from the digitized signals. In some cases, the controllers 106A compute measurement statistics based on qubit state information from multiple shots of a quantum program. For example, each shot may produce a bitstring representing qubit state measurements for a single execution of the quantum program, and a collection of bitsrings from multiple shots may be analyzed to compute quantum state probabilities.

In some implementations, the controllers 106A include one or more clocks that control the timing of operations. For example, operations performed by the controllers 106A may be scheduled for execution over a series of clock cycles, and clock signals from one or more clocks can be used to control the relative timing of each operation or groups of operations. In some implementations, the controllers 106A may include classical computer resources that perform some or all of the operations of the servers 108 described above. For example, the controllers 106A may operate a compiler to generate binary programs (e.g., full or partial binary programs) from source code; the controllers 106A may include an optimizer that performs classical computational tasks of a hybrid classical/quantum program; the controllers 106A may update binary programs (e.g., at runtime) to include new parameters based on an output of the optimizer, etc.

The other quantum computer system 103B and its components (e.g., the quantum processing unit 102B, the signal hardware 104B and controllers 106B) can be implemented as described above with respect to the quantum computer system 103A; in some cases, the quantum computer system 103B and its components may be implemented or may operate in another manner.

In some implementations, the quantum computer systems 103A, 103B are disparate systems that provide distinct modalities of quantum computation. For example, the computer system 101 may include both an adiabatic quantum computer system and a gate-based quantum computer system. As another example, the computer system 101 may include a superconducting circuit-based quantum computer system and an ion trap-based quantum computer system. In such cases, the computer system 101 may utilize each quantum computing system according to the type of quantum program that is being executed, according to availability or capacity, or based on other considerations.

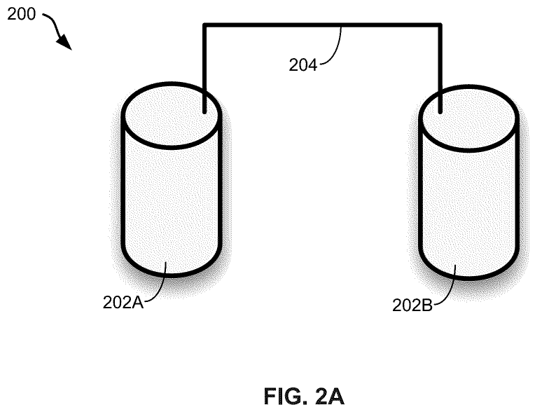

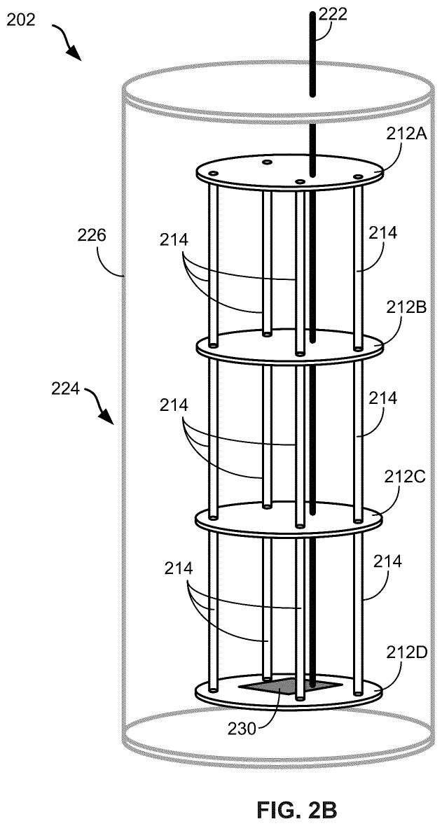

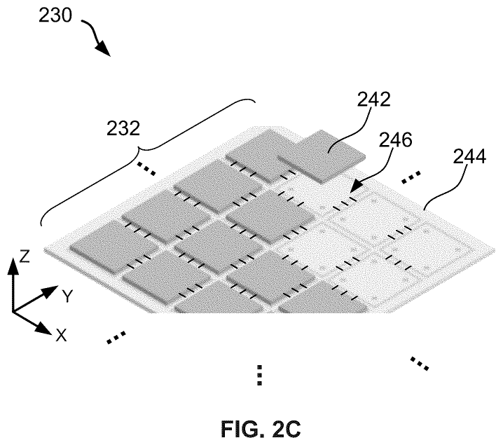

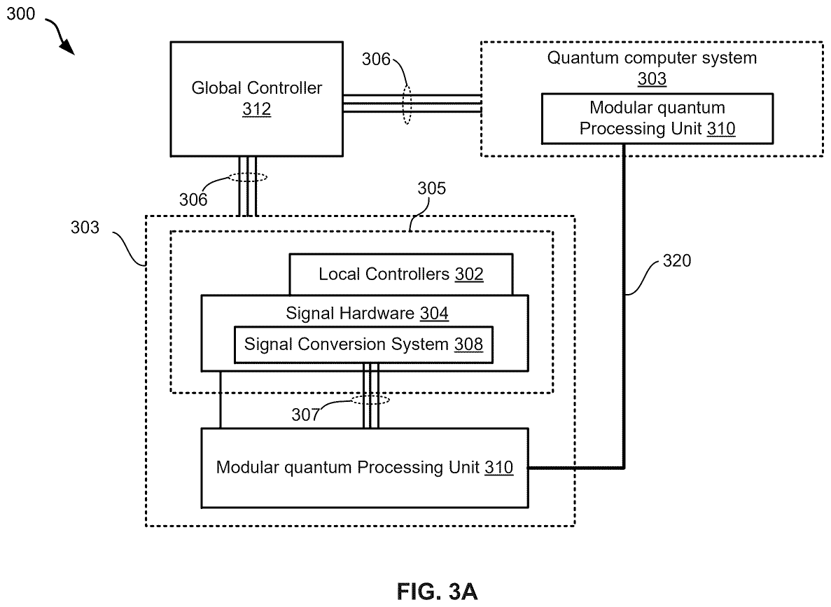

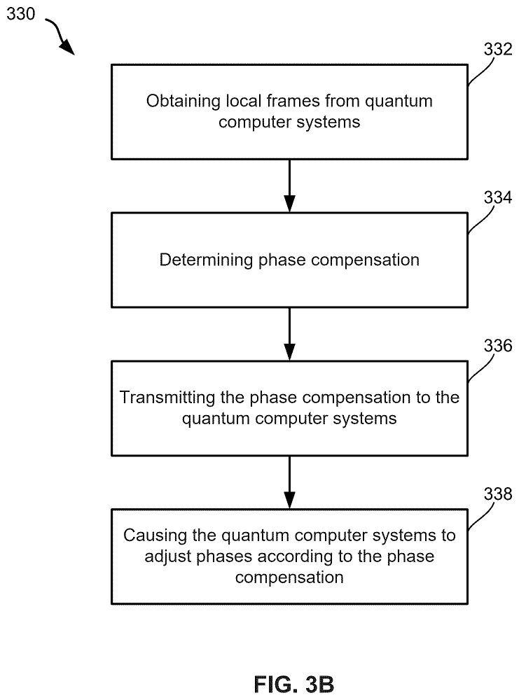

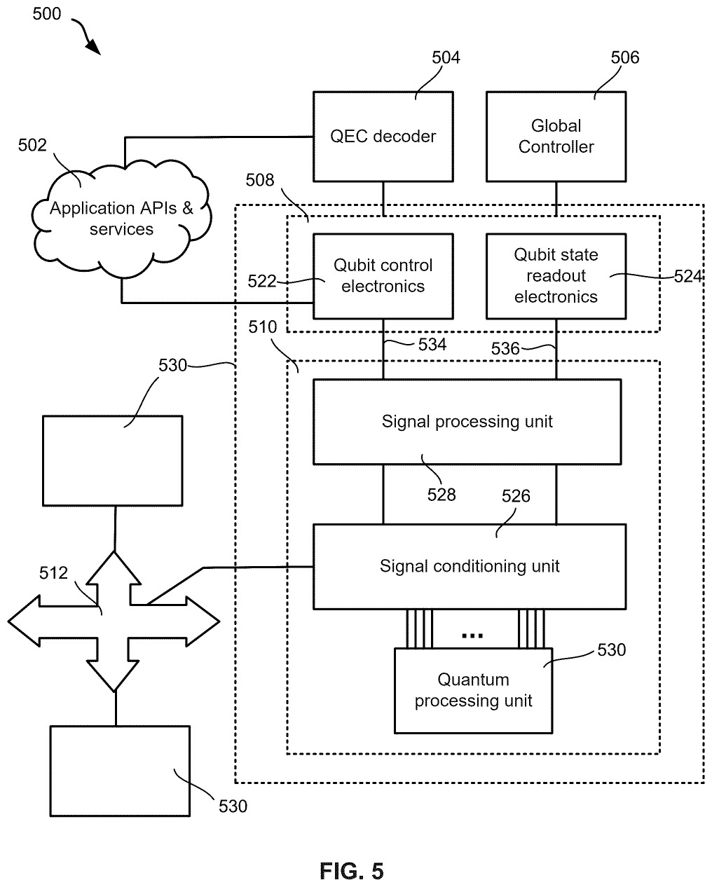

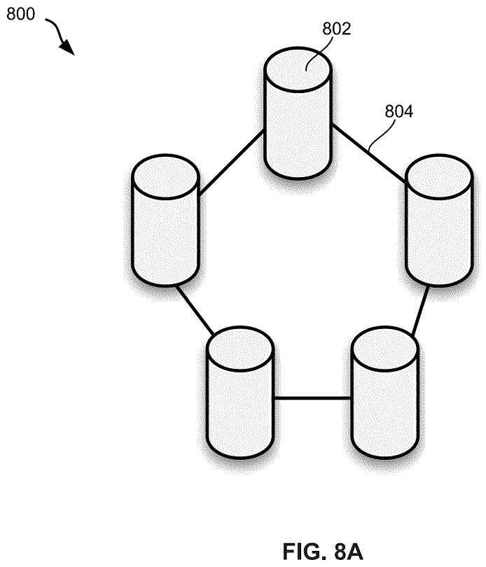

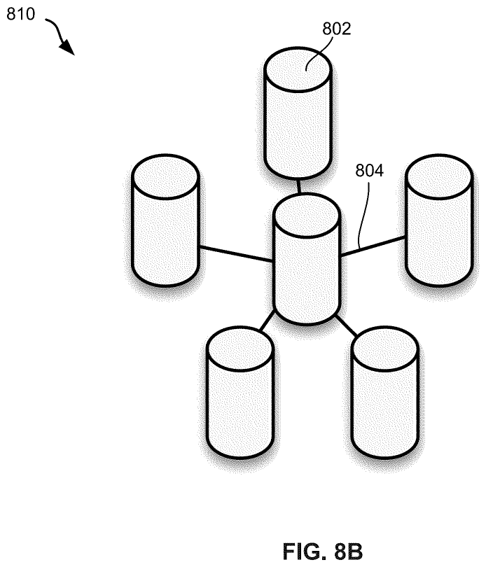

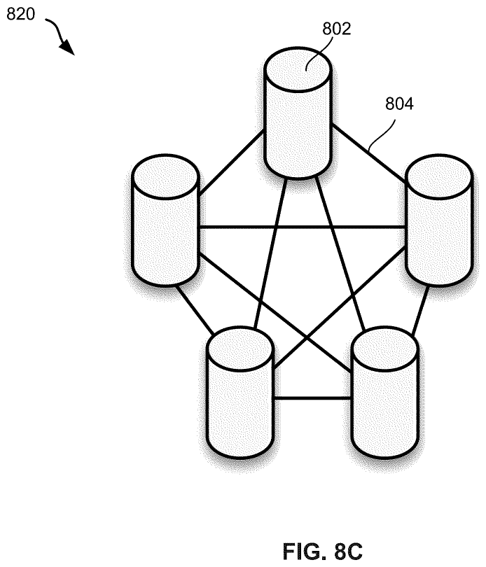

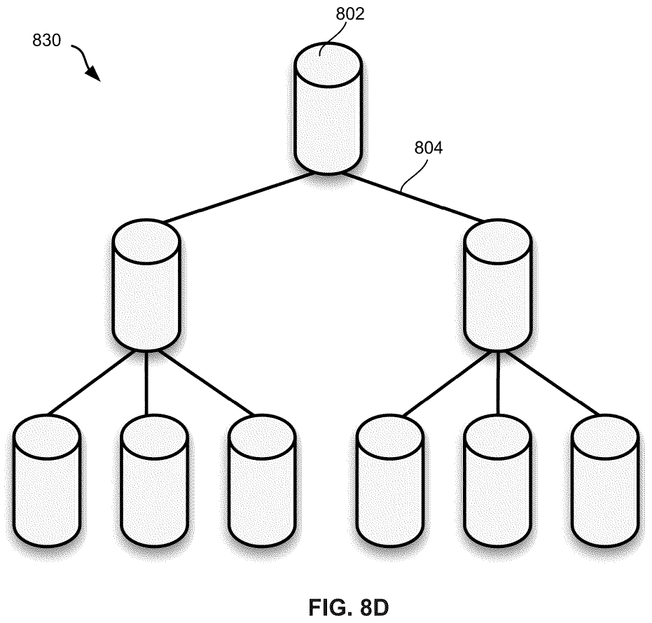

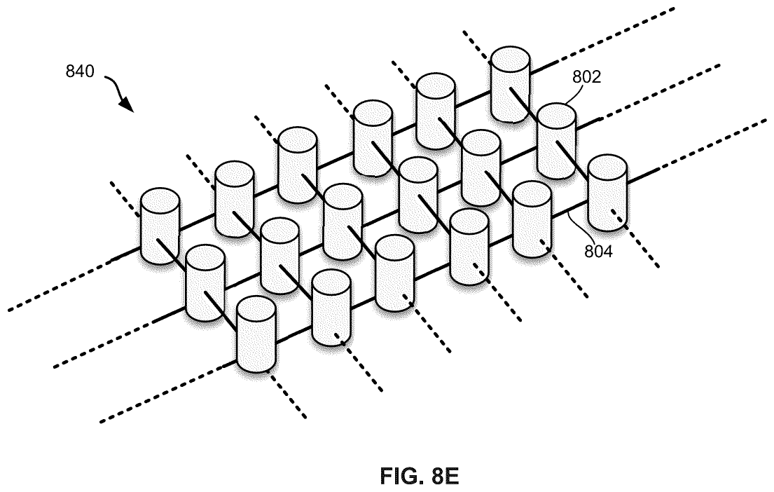

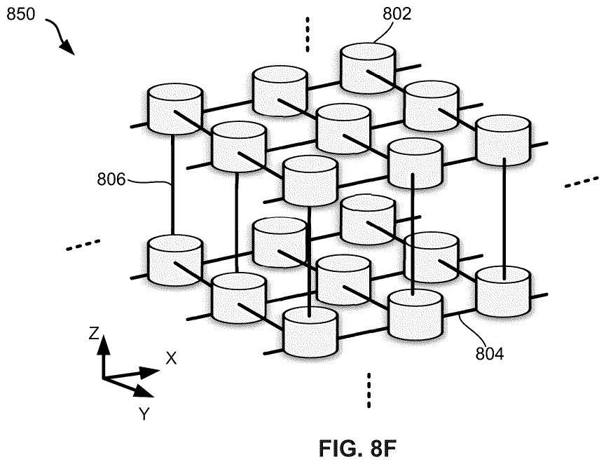

FIG. 2A is a schematic diagram showing aspects of an example quantum computer cluster 200. As shown in FIG. 2A, the example quantum computer cluster 200 includes two quantum computer systems, e.g., a first quantum computer system 202A and a second quantum computer system 202B. In some implementations, each of the first and second quantum computer systems 202A, 202B is implemented as the quantum computer system 103, 202, 303 in FIGS. 1, 2B, and 3, or in another manner. Each of the first and second quantum computer systems 202A, 202B includes a modular quantum processing unit enclosed in a dilution refrigerant system (e.g., the dilution refrigerant system 224 in FIG. 2B). The modular quantum processing units in the first and second quantum computer system 202A, 202B are communicably coupled to each other through a coherent interlink 204. In some instances, the coherent interlink 204 is configured to connect qubit devices in distinct modular quantum processing units of the first and second quantum computer system 202A, 202B. The example quantum computer cluster 200 may include additional or different features, and the components of a computer cluster 200 may operate as described with respect to FIG. 2A or in another manner. For example, the example quantum computer cluster 200 may include a set of quantum computer systems 202 interconnected to one another via respective coherent interlinks in various topologies (FIGS. 8A-8F). For another example, the example quantum computer cluster 200 includes a global controller (e.g., the global controller 312, 506 in FIGS. 3, 5) configured to determine phase compensation and to maintain phase coherence on control signals.

In some implementations, a modular quantum processing unit of the quantum computer system 202A, 202B includes a two-dimensional or three-dimensional array of quantum processor chips that are interconnected to each other. Each of the quantum processor chips may include a two-dimensional or three-dimensional array of quantum circuit devices (e.g., qubit devices, coupler devices, resonator devices, etc.). In some cases, the quantum processor chips are supported on one or more shared substrates and interconnected by circuitry or devices on the respective shared substrate. For example, a subset of the quantum processor chips in the modular quantum processing unit may be supported on a common cap wafer to form a quantum processor module. In this case, quantum circuit devices on the edges of the quantum processor chips are interconnected by inter-chip coupler devices on the common cap wafer. For another example, a quantum processor chip in the modular quantum processing unit may be supported on a respective cap wafer to form a quantum processor module. In this case, quantum circuit devices on the edges of the quantum processor chip are interconnected to other quantum circuit devices on the edges of a distinct quantum processor chip through inter-module coupler devices on a common carrier substrate. In some examples, the modular quantum processing unit of a quantum computer system 202A, 202B may be configured in another manner. In some implementations, the modular quantum processing unit of the first and second quantum computer system 202A, 202B are implemented as the modular quantum processing unit 230, 310, 420, 530 in FIGS. 2B, 2C, 3, 4A-4B, 5.

Each of the quantum processor chips in a modular quantum processing unit includes a superconducting quantum circuit. The superconducting quantum circuit can include quantum circuit devices, for example, qubit devices (e.g., transmon devices, fluxonium devices, or other types of superconducting qubit devices), coupler devices (e.g., capacitive coupler device, tunable-frequency coupler device, or others), readout devices, or other types of quantum circuit devices that are used for quantum information processing in the modular quantum processing unit. The superconducting quantum circuit of each of the quantum processor chips may include one or more Josephson junctions, capacitors, inductors, and other types of circuit elements.

In some implementations, the coherent interlink 204 is configured to maintain coherence between qubit devices from distinct quantum computer systems of the quantum computer cluster housed in separate dilution refrigerant systems. In some implementations, the coherent interlink 204 includes a superconducting interconnect which can carry signals in the RF or microwave regime to create entanglement among remote qubit devices from distinct quantum computer systems in separated dilution refrigerator systems. In certain instances, the coherent interlink 204 includes a superconducting cabling, a transmission line, and other superconducting circuit components that are maintained in a cryogenic environment. For example, when a two-qubit quantum logic gate is applied on two qubit devices from distinct quantum computer systems of the quantum computer cluster housed in separate dilution refrigerant systems, a superconducting coherent interlink 204 may include tunable-frequency coupler devices which can be enabled or disabled by tuning an external magnetic flux to enable or disable the coupling between a qubit device and the transmission line. For another example, when a multi-qubit quantum logic gate is applied on three or more qubit devices from distinct quantum computer systems of the quantum computer cluster housed in separate dilution refrigerant systems, respective coupler devices from respective superconducting coherent interlinks 204 can be controlled, for example, by respective local control systems (e.g., the control system 105 in FIG. 1) to create the entanglement.

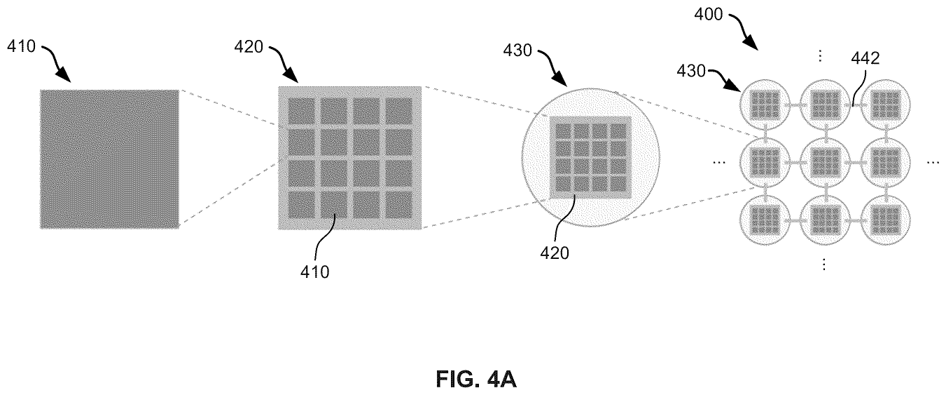

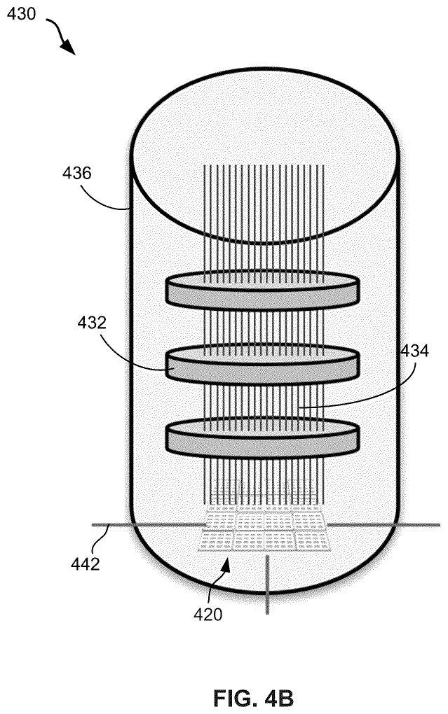

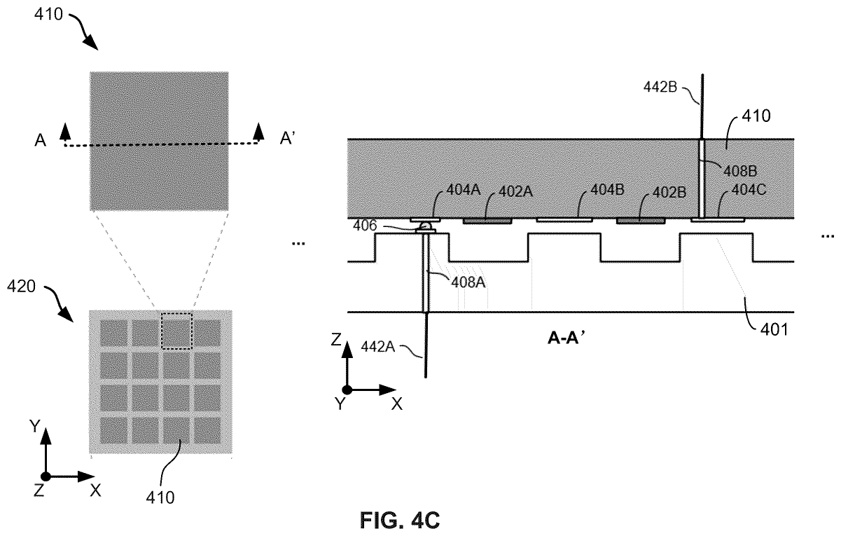

In some instances, the coherent interlink 204 may be implemented as a coherent optical interconnect which can carry signals in the optical regime to control qubit devices, drive qubit devices, and generate entanglement between qubit devices from distinct quantum computer systems in separated dilution refrigerator systems. In this case, the coherent interlink 204 includes optical fibers and other optical components that may be operated at room temperature. In this case, the coherent interlink 204 may include optical components that can be controlled or tuned to maintain the coherence between qubit devices from distinct quantum computer systems in separated dilution refrigerator systems. In this case, the respective control systems of the quantum computer system may include RF-to-optical/optical-to-RF conversion devices as part of signal hardware, which can maintain coherence being used as needed (e.g., the signal hardware 304 in FIG. 3A). In some instances, the coherent interlink 204 may be implemented as the coherent interlink 442, 512 in FIGS. 4A-4B, 5, or in another manner.

In some implementations, when two qubit devices from distinct quantum computer systems in separated dilution refrigerator systems are entangled via the coherent interlink 204, relative delays and phases between control signals transmitted on respective control signal lines from respective control systems are calibrated so that when two qubits are entangled with a two-qubit quantum logic gate (e.g., an iSWAP gate), the frame phase can be exchanged between the two control systems of the two distinct quantum computer systems involved. This measurement and calibration process is routine but requires quantum processor time to perform. As the quantum computer cluster 200 grows and the number of quantum computer systems 202 increases, time that is required to measure these relative delays and phases increases. In some instances, techniques, such as time transfer, can be used to compensate for drifts in the phases between the two respective control systems. In particular, copies of the local reference oscillators at the two respective control systems can be communicated to a global controller (e.g., the global controller 312, 506 in FIGS. 3 and 5) where relative phases can be determined by a comparison circuit (e.g., phase detector) and a phase compensation can be determined to appropriately compensate for the difference or changes in phase between the two respective control systems. In some instances, this compensation can be done electrically or with things like fiber stretchers. For qubit devices from distinct quantum processor modules within the same quantum computer system 202, which are locally environmentally controlled to keep phases stable within the local control system, the local reference oscillators can be directly compared pairwise.

In some instances, relative delays and phases between control signals in separate quantum computer systems may be determined even when entanglement between qubit devices from the separate quantum computer systems is needed without applying a multi-qubit quantum logic gate. In some instances, relative delays and phases between control signals in separate quantum computer systems may be determined without creating entanglement between qubit devices from the separate quantum computer systems. In some instances, relative delays and phases may be determined in other situations.

In some implementations, when the quantum computer cluster 200 includes three or more quantum computer systems 202, the quantum computer systems 202 may be communicably coupled to one another via respective coherent interlinks 204 to form various topologies. For example, a quantum computer cluster 200 may have a chain topology where each quantum computer system is connected to a next quantum computer system in a linear fashion with the first and last quantum computer systems terminating the line; a ring topology where all the quantum computer systems are connected to two other quantum computer systems in a closed loop (e.g., the example topology 800 shown in FIG. 8A), a star topology where all the quantum computer systems are connected to a central quantum computer system (e.g., the example topology 810 shown in FIG. 8B), a mesh topology where each quantum computer system is communicably connected to every other quantum computer systems (e.g., the example topology 820 shown in FIG. 8C), a tree topology where quantum computer systems are arranged in a hierarchical structure (e.g., the example topology 830 shown in FIG. 8D), or a hybrid topology, where quantum computer systems are communicably connected in two or more different topologies. (e.g., FIGS. 8E, 8F)

In some instances, in a quantum computer cluster with a tree topology (e.g., the hierarchical topology shown in FIG. 8D), first quantum computer systems residing at a lower level of the tree topology may obtain a copy of a reference oscillator from a second quantum computer system residing at an immediate higher level of the tree topology. In this case, oscillators of the first quantum computer systems are tied to the same reference oscillator of the second quantum computer system with the same round-trip phase compensation scheme. In some instances, the oscillator of each of the first quantum computer systems may be also used as a reference oscillator for third quantum computer systems residing at an immediate lower level of the tree topology. These general approaches for compensation can also be used for the coherent interlinks between quantum computer systems to handle the propagation delays for quantum information being exchanged between different pairs of quantum computer systems.

When the quantum computer cluster 200 has a fully connected mesh topology, all qubit devices within a quantum computer system 202 can be connected to all other qubit devices in other quantum computer systems 202 within the quantum computer cluster 200. In this case, a total number of N×D×(D+1)/2 coherent interlinks 204 in the quantum computer cluster 200 is required, where N is the number of qubit devices within each quantum computer system 202; and D is the number of quantum computer systems 202, assuming the quantum computer systems 202 include the same number of qubit devices. In some instances, the connectivity can be reduced at the expense of the number of “hops”. it requires to entangle or exchange quantum information between distant qubits. In some implementations, A hop is a use of a single coherent interlink to entangle two qubits from two different quantum computer systems. For example, when quantum computer cluster includes three quantum computer systems A, B and C connected by respective coherent interlinks between the quantum computer systems A and B and between the quantum computer systems B and C (e.g., in a chain topology), qubit devices in the quantum computer systems A and C that are not directly connected by coherent interlinks may be entangled using two hops. For example, a qubit device of the quantum computer system A may be entangled with a qubit device of the quantum computer system B via a first coherent interlink; and the qubit device of the quantum computer system B may be further entangled with the qubit device of the quantum computer system C via a second coherent interlink. For example, if the quantum processor units 430 are connected in a “hypercube” topology, this could reduce the number of coherent links to roughly N×D×log₂ D, with only log₂ D hops required in the worst case to exchange information.

In some implementations, the topology of a quantum computer cluster may be configured, adjusted, or otherwise changed. For example, when a first quantum computer system in a quantum computer cluster needs to be offline for calibration or maintenance, a first set of coherent interlinks connecting second quantum computer systems to the first quantum computer system can be disabled and each of the second quantum computer systems may enable a second distinct set of coherent interlinks to allow each of the second quantum computer systems to be communicably coupled to other quantum computer systems. In this case, each quantum computer system in the quantum computer cluster may be communicably coupled with every other quantum computer system in the quantum computer cluster. In some instances, the global controller of the quantum computer cluster may be informed with the scheduled offline of the first quantum computer system. Prior to executing any quantum program, the global controller may trigger new measurement and calibration processes to determine a relative phase between two newly connected quantum computer systems; obtain a predetermined relative phase; generate a new compensation for at least one of the two newly connected quantum computer systems based on the relative phase; communicate the new compensation to respective local control systems of at least one of the two newly connected quantum computer systems; or may be configured to perform other operations.

FIG. 2B is a block diagram showing aspects of the example quantum computer system 202 in the example quantum computer cluster 200 in FIG. 2A. As shown in FIG. 2B, the quantum computer system 202 includes a modular quantum processing unit 230 supported on a thermal stage and enclosed in a dilution refrigerator system 224. As shown in FIG. 2B, the example dilution refrigerator system 224 includes multiple thermal stages 212A, 212B, 212C, and 212D. In some implementations, the example dilution refrigerator system 224 may be used to expose devices and samples to environments of very low temperature (e.g., T<120 K). In some implementations, such environments are thermally isolated through insulating walls and are evacuated, typically having a pressure in the range of 10³ mbar to 10⁻⁹ mbar, thereby allowing the example dilution refrigerator system 224 to operate at stable temperatures without appreciable thermal losses.

In some implementations, the one or more thermal stages 212A, 212B, 212C, 212D may correspond to radiation shields, thermalization plates, or both. In some instances, a thermal stage 212 in the dilution refrigerator system 224 may be formed of a material having a high thermal conductivity at cryogenic temperatures, such as below 120 K. For example, a thermal stage 212 may be formed of a material having a thermal conductivity of at least 1 W/(m·K) as measured at 4 K. In some examples, a high thermal conductivity allows the thermal stage 212 to mitigate the development of temperature gradients, thereby maintaining a substantially uniform temperature across their respective masses. In some implementations, such material in a thermal stage 212 may include oxygen-free high conductivity copper and its alloys, including a C101 copper alloy or a beryllium-copper alloy (e.g., Cu with 0.5-3% Be) or another type of alloy.

In some instances, the dilution refrigerator system 224 may include any number of thermal stages 212 to support subsystems, devices, and samples for cryogenic refrigeration. As a result, the dilution refrigerator system 224 may position the thermal stages 212 to define a spatial sequence of thermal stages, such as in a linear sequence. FIG. 2B depicts four thermal stages 212A, 212B, 212C, 212D in an equally spaced linear sequence. In some implementations, the dilution refrigerator system 224 may include any number and spacing of thermal stages 212 as needed. In the example shown in FIG. 2B, the dilution refrigerator system 224 includes one or more structural supports 214 to position the thermal stages 212 into the spatial sequence of thermal stages. In some examples, the structural supports 214 may be formed of a material having a low thermal conductivity at cryogenic temperatures, e.g., less than 0.5 W/(m·K) at or below 50 K, such as a stainless-steel alloy or a glass-epoxy laminate of G10 grade. In this case, the structural supports 214 thus additionally impede a flow of heat between the thermal stages 212. As such, the dilution refrigerator system 224 may include one or more thermal stages 212 dedicated to a specific temperature during operation. For example, the dilution refrigerator system 224 may be configured such that each thermal stage 212 operates at a progressively decreasing temperature as the depth of the dilution refrigerator system 224 increases.

In some implementations, the dilution refrigerator system 224 may also include one or more refrigeration systems (not shown) thermally coupled to each of the thermal stages 212. For example, the dilution refrigerator system 224 may include a pulse-tube refrigeration system coupled to a second lowest-temperature thermal stage 212C and a ³He/⁴He dilution refrigerator system thermally coupled to a lowest-temperature thermal stage 212D. The dilution refrigerator system 224 establishes specific operating temperatures for the thermal stages 212 to which they are respectively thermally coupled. In some implementations, the dilution refrigerator system 224 may define a distribution of operating temperatures along the spatial sequence of thermal stages 212. In some implementations, a pulse-tube refrigeration unit may be configured to optimally extract heat at temperatures to about 4 K and a ³He/⁴He dilution refrigerator unit may be configured to optimally extract heat at temperatures below 1 K.

In the example shown in FIG. 2B, a modular quantum processing unit 230 is configured on the lowest-temperature thermal stage 212D of the dilution refrigerator system 224. In some implementations, the modular quantum processing unit 230 may receive and transmit signals via transmission links 222. The transmission links 222 can transmit control signals to the modular quantum processing unit 230, and readout signals out of the dilution refrigerator system 224. In some instances, the signals communicated on the transmission links 222 are microwave or radio-frequency frequency signals.

In some other instances, the signals communicated on the transmission links 222 are optical frequency signals. In some implementations, the transmission links 222 include one or more optical fibers. In some instances, the optical fibers may include one or more single-mode optical fibers, one or more multi-mode optical fibers, or a combination. In this case, the modular quantum processing unit 230 includes a signal conversion system which receives signals in a mm-wave, terahertz, or optical regime and converts to signals in a microwave or radio-frequency regime for the quantum circuit devices in the modular quantum processing unit 230. In some implementations, the signal conversion system can obtain readout signals regime from the quantum circuit devices in the modular quantum processing unit 230 in the microwave or radiofrequency and converts to signals in the mm-wave, terahertz, or optical regime. In some implementations, the transmission links 222 may carry signals from a global controller (e.g., the global controller 312 of the computing system 300 in FIG. 3A) to the modular quantum processing unit 230, or directly between the modular quantum processing units 230 of the two quantum computing units 202 in FIG. 2A. In some implementations, the signal conversion system may be implemented as the signal conversion system 308 in FIG. 3A or in another manner.

As shown in FIG. 2B, the transmission links 222 in the dilution refrigerator system 224 are configured separately from the structural supports 214 through the thermal stages 212. In certain instances, the transmission links 222 may be arranged or routed in another manner to optically couple the other signal hardware and the signal conversion system.

In some implementations, the transmission link 222 includes various control signal lines, e.g., flux bias control lines, qubit drive lines (e.g., gate lines, microwave control lines directly drive the qubit, charge control lines, or XY control lines), and readout signal lines, which have different characteristics.

For example, flux bias control lines need relatively low data rate for envelope definition (e.g., the data rate is equal to or greater than 200 Msps), which can be balanced with the need for faster DAC devices (e.g., 1 Gsps or perhaps a bit higher) to implement predistortion. Frequencies may be roughly less than 1 GHz; and 2 Gsps can directly generate the needed waveforms. Furthermore, flux bias control lines require stable DC performance (e.g., low 1/f noise). Such stable DC performance may be achieved by measuring the output when idle (to avoid confusion from pulses) and comparing to a stable reference. For example, flux bias control lines require high dynamic range (e.g., low noise, high amplitude output with low distortion). For example, 16-bits may be a good fit between providing amplitude up to ½ of flux period and quantization noise sufficiently low compared to room temperature thermal noise (e.g., ˜typically 90 dB between these two extents).

In some implementations, qubit drive lines are typically one per qubit device, although fewer may be needed with multiplexing. For qubit drive lines require low data rates for envelope definition; as discussed above, it might be useful to have higher data rates to define optimal control pulses. Furthermore, it is desired to access a bandwidth of around the anharmonicity so that the f02/2 frequency can be produced. No DC coupling is required. Pre-compensation is useful to suppress reflections and other non-idealities in the transmission path between the local controller and the qubit devices, so pre-distortion filtering is desired in the gate lines. Digital interpolation and up-sampling to directly generate the RF pulses at f01 frequencies which are typically 3-6 GHz is also desired. On-chip analog I/Q mixers may also be used; this would enable accessing even higher frequencies in case higher qubit frequencies are to be accommodated.

In some implementations, readout transmit lines have the same general specifications as the qubit drive lines. In some implementations, multiple sequencers are configured to drive a single readout transmit line for readout multiplexing. A readout transmit line is used to transmit a pulse at the frequency of a readout resonator that is coupled to a respective qubit device.

Readout receive lines have signal to noise ratio of <1 in the full readout bandwidth (e.g., at a sampling frequency of 500-1000 MHz in which all readout signals occur will result in data that looks like noise, even though the readout signal is buried in it). In some instances, a readout receive line receives a resulting pulse after it has interacted with the readout resonator. The amplitude and phase of the received pulse on the readout receive line is compared to the pulse transmitted to the readout resonator. In some instances, a readout receive line may be one end of a transmission line that is coupled to a readout resonator; and a readout transmit line may be connected to the opposite end of the same transmission line. In this case, analog-to-digital conversion (ADC) devices with a low number of bits can be used. Such low-bit-depth ADC devices are amenable to implementation using a “flash” architecture, with 2ⁿ comparators all operating in parallel to pinpoint the input voltage with extremely low latency. Latency is then just propagation delay though comparator and decode logic, which could be of order 1 ns. High sample rate can be used to directly sample the readout signal, either in a high Nyquist zone (under-sampling the raw signal) or with standard Nyquist limit (two times of the highest frequency of interest) followed by digital filtering/down-sampling. However, sampling at the standard Nyquist limit (e.g., 20 Gsps to access readout signals up to 10 GHz) and feeding the data directly into a FIR filter with dynamically settable coefficients can be implemented. These filters would be configured to perform a matched filter on the incoming signal, directly rejecting the noise at all frequencies outside the signal of interest while simultaneously enhancing the sensitivity to the state of the qubit. The output of this filter will provide the state of the qubit with of order 1 ns latency relative to the end of the readout signal. The raw output of the filter can either be simply compared with a threshold to discriminate the |0> and |1> states, or can be fed into additional logic to implement more complex discriminators (e.g., determining higher states, or using a more advanced classifier or some sort of neural network classifier).

FIG. 2C is a block diagram showing a perspective view of the example modular quantum processing unit 230 shown in FIG. 2B. The modular quantum processing unit 230 includes a quantum processor module 232. The quantum processor module 232 includes an array of quantum processor chips 242 on a substrate 244. Each quantum processor chip 242 includes a superconducting quantum circuit with an array of qubit devices. As shown in FIG. 2C, qubit devices at the edges of neighboring pairs of quantum processor chips 242 are connected to each other through inter-chip coupler devices 246. The inter-chip coupler devices 246 may be capacitive, inductive, galvanic, or combinations of these. The inter-chip coupler devices 246 are provided by circuitry on the substrate 244, which is operably connected to ports, leads, bonds or other types of hardware interfaces on the respective quantum processor chips 242. Couplings provided by the inter-chip coupler devices 246 can be used to apply multi-qubit quantum logic gates or other types of operations to qubits in distinct quantum processor chips. The quantum logic gates mediated by the inter-chip coupler devices 246 may be used to provide entanglement between qubit devices in distinct quantum processor chips 242; in some cases, other schemes such as remote multi-qubit measurement can be used to entangle qubit devices in distinct quantum processor chips 242.

The quantum processor chips 242 of the quantum processor module 232 can be arranged on the substrate 244 as an array in a two-dimensional or three-dimensional lattice structure. Eleven of the quantum processor chips 242 in the quantum processor module 232 are shown in FIG. 2C, but the quantum processor module 232 is scalable to include many more quantum processor chips 242 (e.g., tens, hundreds, thousands, etc.). In some instances, the modular quantum processing unit 230 includes multiple quantum processor modules 232, where each of the multiple quantum processor modules 232 includes a substrate 244 supporting a subset of quantum processor chips 242 of the modular quantum processing unit 230. In this case, qubit devices residing at the edges of the quantum processor chips 242 that reside at the edges of neighboring quantum processor modules 232 may be communicably coupled to each other through inter-module coupler devices. In some implementations, the multiple quantum processor modules 232 may be supported on a common carrier substrate which includes superconducting circuitry. The inter-module coupler devices may be part of the superconducting circuitry of the common carrier substrate. In some implementations, the example modular quantum processing unit 230 may include additional and different features or components and components of the example modular quantum processing unit 230 may be implemented in another manner.

In the example shown in FIG. 2C, the quantum processor chips 242 are arranged in a rectilinear (e.g., rectangular, or square) array on the substrate 244 that extends in two spatial dimensions (e.g., along the X-Y plane) on a surface of the substrate 244. In some implementations, the quantum processor chips 242 can be arranged in another type of ordered array. In some instances, the rectilinear array also extends in a third spatial dimension (e.g., along the Z axis), for example, to form a cubic array or another type of three-dimensional module assembly.

In some implementations, each of the quantum processor chips 242 in the quantum processor module 232 of the modular quantum processing unit 230 includes a superconducting quantum circuit. In some implementations, a superconducting quantum circuit of the quantum processor chips 242 includes one or more qubit devices that can operate collectively as a logical qubit, or as multiple logical qubits. In certain instances, the superconducting quantum circuit of a quantum processor chip 242 includes quantum circuit devices, such as fixed-frequency qubit devices, tunable-frequency qubit devices, coupler devices, readout resonators, or other types of quantum circuit devices. In some examples, each of the qubit devices in a quantum processor chip 242 can be encoded with a single bit of quantum information.

Typically, each of the qubit devices in a quantum processor chip 242 has two eigenstates that are used as computational basis states (e.g., |0> and |1>), and each qubit device can transition between its computational basis states or exist in an arbitrary superposition of its computational basis states. In some examples, the two lowest energy levels (e.g., the ground state and first excited state) of each qubit device are defined as a qubit and used as computational basis states for quantum computation. In some examples, higher energy levels (e.g., a second excited state or a third excited state) can be used to define a qubit, a qutrit, or a multi-level quantum computational device in some instances. Quantum states (e.g., qubits) defined by respective qubit devices in a single quantum processor chip 242 can be manipulated by control signals, or read by readout signals, generated by a control system, e.g., the control system 305 in FIG. 3A. The qubit devices in a single quantum processor chip 242 can be controlled individually, for example, by delivering control signals from a control system to the respective qubit devices in the quantum processor chip 242. In some cases, readout devices can detect the states of the qubit devices, for example, by interacting directly with the respective qubit devices.

Although each individual qubit device defines a single qubit, a lattice of qubit devices in a quantum processor chip 242 may operate collectively as a single logical qubit. For example, a stabilizer code or another type of quantum error correction scheme can be applied to the lattice of qubit devices. In some cases, one of the qubit devices operates as a data qubit, other qubit devices in the lattice operate as ancilla qubits, and a quantum error correction scheme is applied to the lattice. The ancilla qubits may be used to detect an error syndrome, which can be used to correct errors on the data qubit. Examples of stabilizer codes include surface codes, color codes and other types of quantum error correcting codes. Accordingly, a quantum processor chip 242 may include qubit devices, connections among the qubit devices, and potentially other hardware features that define an appropriate lattice for one or more quantum error correction codes to be applied.

In some instances, all of the quantum processor chips 242 may include the same superconducting quantum circuit with the same circuit design and the same functionality. For example, two quantum processor chips 242 in the quantum processor module 232 may include identical circuit design, e.g., the same number of qubit devices, arrangements of signal lines, etc. In this case, two quantum processor chips 242 in the quantum processor module 232 may be fabricated through the same fabrication process.

In certain instances, the quantum processor chips 242 may include different superconducting quantum circuits with distinct circuit designs and distinct functionalities. For example, two quantum processor chips 242 in the quantum processor module 232 have different numbers of qubit devices, different connections (e.g., different intra-module connections) between qubit devices, different arrangements of signal lines, etc. In this case, two quantum processor chips 242 in the quantum processor module 232 are fabricated using different fabrication processes. In some cases, multiple different fabrication processes are used to produce a batch of quantum processor chips 242. In certain instances, design and fabrication processes of superconducting quantum circuit of different quantum processor chips 242 may be separately optimized.

In some instances, after fabrication, the quantum processor chips 242 may be evaluated, for example, using qubit frequency testing, optical micrograph analysis, gate performance testing, coherence time testing, and other types of testing. The evaluations can be used to characterize the quantum processor chips 242 according to their design specifications. In some cases, the quantum processor chips 242 may be categorized based on the evaluation results. For example, quantum processor chips 242 may be sorted into multiple categories based on pre-determined criteria for each category. In some cases, the categories are indicative of a relative quality of a quantum processor module. In some cases, the categories are indicative of the functionality of a quantum processor chip 242, the number of working qubit devices in a quantum processor chip 242, the connectivity of the qubit devices at the edges of a quantum processor chip 242, or a combination of these and other criteria. A subset of the quantum processor chips 242 may be selected from appropriate categories based on a specified performance level for the modular quantum processing unit 230.

The superconducting QuIC in a quantum processor chip 242 shown in FIG. 2C is fabricated on a substrate. In certain instances, the substrate supporting the superconducting QuIC in a quantum processor chip 242 may be an elemental semiconductor, for example silicon (Si), germanium (Ge), selenium (Se), tellurium (Te), or another elemental semiconductor. In some instances, the substrate may also include a compound semiconductor such as aluminum oxide (sapphire), silicon carbide (SiC), gallium arsenic (GaAs), indium arsenide (InAs), indium phosphide (InP), silicon germanium (SiGe), silicon germanium carbide (SiGeC), gallium arsenic phosphide (GaAsP), gallium indium phosphide (GaInP), or another compound semiconductor. In some instances, the substrate may also include a superlattice with elemental or compound semiconductor layers. In certain instances, the substrate includes an epitaxial layer. In some examples, the substrate may have an epitaxial layer overlying a bulk semiconductor or may include a semiconductor-on-insulator (SOI) structure.

The superconducting quantum circuit in a quantum processor chip 242 may include superconductive materials and can be formed by patterning one or more superconductive (e.g., superconducting metal) layers or other materials on the surface of the substrate 244. In some implementations, each of the one or more superconductive layers include a superconducting metal, such as aluminum (Al), niobium (Nb), tantalum (Ta), titanium (Ti), rhenium (Re), vanadium (V), tungsten (W), zirconium (Zr), or another superconducting metal. In some implementations, each of the one or more superconductive layers may include a superconducting metal alloy, such as molybdenum-rhenium (Mo/Re), niobium-tin (Nb/Sn), or another superconducting metal alloy. In some implementations, each of the superconductive layers may include a superconducting compound material, including superconducting metal nitrides and superconducting metal oxides, such as titanium-nitride (TiN), niobium-nitride (NbN), zirconium-nitride (ZrN), hafnium-nitride (HfN), vanadium-nitride (VN), tantalum-nitride (TaN), molybdenum-nitride (MoN), yttrium barium copper oxide (Y—Ba—Cu—O), or another superconducting compound material. In some instances, the superconducting quantum circuit in a quantum processor chip 242 may include multilayer superconductor-insulator heterostructures.

In some implementations, the superconducting quantum circuit in a quantum processor chip 242 is fabricated on the top surface of a substrate and patterned using a microfabrication process or in another manner. For example, quantum circuit devices in a superconducting quantum circuit of a quantum processor chip 242 may be formed by performing at least some of the following fabrication steps: using chemical vapor deposition (CVD), physical vapor deposition (PVD), atomic layer deposition (ALD), spin-on coating, and/or other suitable techniques to deposit respective superconducting layers on the substrate; and performing one or more patterning processes (e.g., a lithography process, a dry/wet etching process, a soft/hard baking process, a cleaning process, etc.) to form openings in the respective superconducting layers.

In the example shown in FIG. 2C, a superconducting quantum circuit in each quantum processor chip 242 can operate as a logical qubit. The respective qubit devices in the quantum processor chip 242 are communicably coupled with associated signal hardware and local controllers (e.g., the signal hardware 304 and the local controllers 302 shown in FIG. 3A or another control system). In certain instances, logic qubit errors at the boundary of quantum processor chips 242 can be decoded, incorporating specific properties of the inter-chip coupler devices 246 and intra-chip connections. For example, a weighted graph decoder can assign higher weight values to connections corresponding to inter-chip syndrome extraction which may have higher error rates due to more error prone inter-chip connections. This may result in an overall higher effective physical error threshold, with the decoding task having the limiting case of decoding 2D syndrome graphs for perfect intra-chip syndrome extraction. In some instances, decoding logical qubit errors allows for correlated error processes localized to one quantum processor chip 242.

In some cases, each quantum processor chip 242 is physically attached, bonded, or connected to the substrate 244. As shown in FIG. 2C, the quantum processor chips 242 are bonded or attached to the substrate 244, for example, using bonding bumps. In some implementations, each of the bonding bumps may include conductive or superconductive materials, such as copper or indium bumps. In some implementations, the bonding bumps can provide electrical communication between the superconducting quantum circuit on the quantum processor chips 242 and circuitry on the substrate 244. In some instances, quantum circuit devices in a superconducting quantum circuit of a quantum processor chip 242 may be communicably coupled, e.g., galvanically, capacitively, or inductively, to the circuitry on the substrate 244. The substrate 244 can provide functional connections (e.g., inter-chip coupler devices 246) between distinct quantum processor chips 242 in the quantum processor module 232 as well as connections between quantum processor chips 242 and the control system. In some examples, the substrate 244 includes circuitry or other types of structures that provide control over the interactions between quantum circuit devices (e.g., qubit devices) in distinct quantum processor chips 242 of the modular quantum processing unit 230. For example, the substrate 244 may include superconducting circuit elements, e.g., ancilla qubit devices or other circuit elements.

In some implementations, the circuitry on the substrate 244 may include a variety of circuit elements to control or readout the qubit devices of the quantum processor chips 242. For example, the circuitry may include flux bias lines which can provide magnetic flux locally to tunable-frequency qubit devices to tune their frequencies. The circuitry may include tunable coupler devices, microwave feedlines, and resonator devices which are capacitively coupled to qubit devices on the quantum processor chips 242 to readout qubits. In some examples, the circuitry may include microwave feedlines which are coupled to one or several of the resonator devices on the quantum processor chips 242 to allow microwave excitation of the resonator devices used to readout qubits. In this case, the circuitry may include microwave drive lines which are capacitively coupled to qubit devices of the quantum processor chips 242 to drive qubits. In some implementations, the substrate 244 includes deterministic, low-loss wiring to mediate coherent interactions between qubit devices from different quantum processor modules 242. In certain instances, the deterministic, low-loss wiring may include, for example, superconducting transmission lines, phononic or photonic waveguides, through-silicon vias, amplifiers, non-reciprocal elements such as circulators or isolators, switches, or another type of structure.

In some instances, the circuitry on the substrate 244 may further include one or more electrically conductive vias. In some implementations, the electrically conductive vias include a superconducting material (e.g., Al, In, Ti, Pn, Sn, etc.). In some implementations, the circuitry can be used as a Faraday cage, which can prevent stray electric fields from reaching the quantum circuit devices on the quantum processor chips 242. In some implementations, the circuitry may also be used to exclude stray magnetic fields from reaching the quantum circuit devices on the quantum processor chips 242.

In some implementations, the circuitry on the substrate 244 may be formed in one or more electrically conductive layers. In other implementations, each of the one or more electrically conductive layers may include a material that has normal conductance at the operating temperature of the example modular quantum processing unit 230. In some implementations, the example modular quantum processing unit 230 can be operated at cryogenic temperatures (e.g., cooled using liquid helium) and each of the one or more electrically conductive layers (or at least a portion) can operate as a superconducting layer at that temperature. In some instances, the substrate 244 may include recesses which can be used to form an enclosure to a quantum circuit device or an enclosure to a control line.

In some implementations, a subset of the one or more electrically conductive vias are electrically coupled with external signal lines, which are used to supply control signals to, or retrieve readout signals from, the quantum processor chips 242 of the example modular quantum processing unit 230. For example, the control signals can be provided to the quantum processor chips 242 from a control system (e.g., the control system 305 in FIG. 3A) or the readout signals can be retrieved from the quantum processor chips 242 to the control system, directly or through the substrate 244.

In some implementations, the quantum circuit devices of the quantum processor chips 242 include qubit devices (e.g., transmon devices, fluxonium devices, or other types of superconducting qubit devices), coupler devices, readout devices or other types of devices that are used for quantum information processing in the modular quantum processing unit 230. The quantum circuit devices may include one or more Josephson junctions, capacitors, inductors, and other types of circuit elements.

The superconducting circuitry at various positions of the substrate 244 may be connected through conductive pathways. For example, conductive lines including a patterned metal coating that covers a portion of the sidewalls of a recess extending from a recessed surface to the first surface can galvanically connect the circuitry on the two surfaces. For another example, the circuitry on two different surfaces may be electrically coupled through conductive vias. In some implementations, the electrically conductive vias can be used to form a continuous ground plane through the example quantum processing unit 230, such that a solidly connected ground plane can be maintained across both the quantum processor modules 242 and the substrate 244. Multiple electrically conductive vias connected to the ground planes located on the first and second surfaces of the substrate 244, and the recessed surface may be arranged in a regular array to avoid a formation of a chip-mode resonance and to mitigate unwanted modes (e.g., coupled slotline mode, parallel-plate waveguide modes, or resonant patch mode). In some instances, the circuitry at different positions of the substrate 244 may be coupled in another manner. In some instances, the one or more electrically conductive vias may include another subset that can be used for thermalization. In this case, the substrate 244 allows better heatsinking of the quantum circuit devices to the refrigeration system using the one or more electrically conductive vias as thermal paths for heat dissipation.

In some instances, quantum circuit devices on the quantum processor chips 242 may be coupled via alternative signal routing levels provided by the circuitry and the electrically conductive vias on the substrate 244. For example, non-neighboring quantum circuit devices on the same quantum processor module 242 without qubit-to-qubit connections (e.g., direct coupling lines on the quantum processor module 242) may be provided by the substrate 244. In some implementations, the circuitry on the substrate 244 may be coupled to the quantum circuit devices on the quantum processor chips 242 using capacitive, inductive, or galvanic connections. In some instances, the circuitry on the substrate 244 may include planar transmission lines, for example coplanar waveguides, substrate integrated waveguides or another type of planar transmission line.

In some implementations, at least one qubit device in the modular quantum processing unit 230 is directly connected to at least one other qubit device of another modular quantum processing unit in a separate quantum computer system via a respective coherent interlink 204. For example, a qubit device may be directly connected to multiple other qubit devices from multiple other quantum computer systems via respective coherent interlinks. In some instances, couplings between the qubit devices and each of the coherent interlinks can be controlled (e.g., enabled or disabled) by supplying control signals from a local control system, which allows the change of the topology of the quantum computer cluster. For example, when the coherent interlink 204 includes a superconducting transmission line and the qubit devices may be coupled to the transmission line via a respective coupler device, e.g., a tunable-frequency coupler device that may be controlled by tuning a coupler magnetic flux. In some implementations, the at least one qubit device that is connected to multiple coherent interlinks may reside at an edge of a quantum processor chip, an edge of a quantum processor module, an edge of the modular quantum processing unit, or any other locations of the modular quantum processing unit. In some implementations, a quantum computer system may be communicably coupled to other quantum computer systems in the quantum computer cluster through distinct qubit devices of the modular quantum processing unit 230. For example, a first qubit device of a first quantum computer system may be coupled to a second quantum computer system via a first coherent interlink; and a second, distinct qubit device of the first quantum computer system may be coupled to a third quantum computer system via a second coherent interlink. In some implementations, other components or devices may be included as part of the modular quantum processing unit or the control system which allow the connection of a quantum computer system to multiple other quantum computer systems in the quantum computer cluster.

In some instances, a coherent interlink 204 may be configured to coherently interconnect multiple pairs of qubits from the two distinct quantum computer systems 202A, 202B by multiplexing. For example, if a waveguide is used as part of a coupling structure between two quantum processor units, the waveguide can be used to couple one pair of qubits via one mode of the waveguide, e.g., the TE10 mode, and have a second pair of qubits coupled via another mode of the waveguide, e.g., the TM10 mode. For another example, when a waveguide has a broad bandwidth, the waveguide can be used to coupler a pair of qubit devices operating at a first frequency within the bandwidth of the waveguide, and a pair of qubit devices operating a second, distinct frequency also within the bandwidth of the waveguide.

FIG. 3A is a schematic diagram showing aspects of an example quantum computer cluster 300. As shown in FIG. 3A, the example quantum computer cluster 300 includes two quantum computer systems 303 and a global controller 312. Each of the two quantum computer systems 303 is communicably coupled to the global controller 312; and the two quantum computer systems 303 are communicably coupled to each other via a coherent interlink 320. Each quantum computer system 303 includes a control system 305 and a modular quantum processing unit 310. In certain implementations, the quantum computer cluster 300 may include additional or different features or components, and the components of the quantum computer cluster 300 may operate as described with respect to FIG. 3A or another manner. For example, the quantum computer cluster 300 may include three or more quantum computer systems communicably coupled to the same global controller 312. and the modular quantum processing unit 310 may be communicably coupled to other modular quantum processing units 310 in distinct quantum computer systems 303 through respective coherent interlinks 320 forming different topologies.

As shown in FIG. 3A, the control system 305 of a quantum computer system 303 includes a local controller 302 and signal hardware 304. In some implementations, the control system 305 may include classical computers, electronic systems, vacuum control systems, refrigerant control systems, or other types of control systems to support operation of the modular quantum processing unit 310. The modular quantum processing unit 310 is supported on a thermal plate of a dilution refrigerant system (e.g., the lowest-temperature thermal plate 212D of the example dilution refrigerant system 224 of FIG. 2B). In some implementations, the control system 305 may be implemented as the control system 105 shown in FIG. 1; and the coherent interlink 320 may be implemented as the coherent interlink 204, 442, 512 in FIGS. 2A, 4A-4B, 5 or in another manner.

In some implementations, the global controller 312 can receive a quantum program from a user (e.g., a user program) and obtain a quantum program by performing a compilation operation. A sequence of quantum logic gates in the quantum program before compilation can be converted to a sequence of native quantum logic gates in the quantum program after compilation. In some instances, the sequence of native quantum logic gates can be applied on qubits defined by qubit devices in the quantum processing unit. In some implementations, a quantum program can be represented, for example, as a quantum Hamiltonian, a sequence of quantum logic gates, a set of quantum machine instructions, or otherwise. The quantum program may correspond to a computational task, a hardware test, a quantum error correction procedure, a quantum state distillation procedure, or a combination of these and other types of operations. In some instances, a quantum program includes a first sequence of quantum logic gates, e.g., single-qubit quantum logic gates, two-qubit quantum logic gates, multi-qubit quantum logic gates, identity gates, and other quantum logic gates. In some instances, the quantum program can be an Quil program generated by a user device (e.g., the user device 110 as shown in FIG. 1), another computer resource outside the local environment of the quantum computer system 103, or in another manner; and received by a quantum computing system (e.g., the control system 105 of the quantum computing system 103 in FIG. 1).

The native quantum program includes a sequence of native quantum logic gates, e.g., single-qubit native quantum logic gates, two-qubit native quantum logic gates, multi-qubit native quantum logic gates, multi-level native quantum logic gates (e.g., qutrit or other qudits), and other types of quantum logic gates to execute the quantum program. To simplify description, a qubit, as referred to herein, may refer to a two-level qubit or any other higher-level system such as qutrits or any other qudit.

In some implementations, the received quantum program is compiled according to the quantum computer system 303 where the quantum program is to be executed. In this case, after compilation, the quantum program includes quantum logic gates that can be executed on quantum circuit devices in the modular quantum processing 310. In some implementations, the quantum program can be compiled by operation of a compiler of the global controller 312 after receiving the quantum program.

In some instances, a native gate set includes a set of quantum logic gates that can be directly executed by the quantum processing unit. After a native gate set for the quantum processing unit is identified, a quantum logic gate in the first sequence of quantum logic gates (e.g., one or more parametric quantum logic gates) in the quantum program can be converted, translated, or otherwise compiled into a native gate sequence in a second sequence of quantum logic gates. Each of the native quantum logic gates in a native gate sequence may be a parametric single-qubit rotation gate, a parametric two-qubit quantum logic gate, a parametric three-qubit quantum logic gate, or another quantum logic gate. In addition to the parametric quantum logic gates, a native gate set may include one or more non-parametric quantum logic gates. For example, a two-qubit quantum logic gate, e.g., CNOT gate, in a received quantum program from a user can be decomposed into several iSWAP gates or a CZ gate that can be directly executed on quantum circuit devices in a quantum computer system or across multiple quantum computer systems 303 that are interconnected via the respective coherent interlinks 320.

When the quantum program before compilation includes more than one quantum logic gates, more than one native gate sequences can be formed, e.g., by parametric decomposition or in another manner. Generally, the one or more native gate sequences are quantum-logically equivalent to the respective one or more quantum logic gates in the quantum program before compilation. In some instances, the local controllers 302 of each of the quantum computer systems 303 can also include a compiler and further provide compiled sub-programs to qubit devices of the quantum processor chips of the modular quantum processing unit 310.

In some implementations, the global controller 312 is configured to perform synchronization and orchestration within the quantum computer cluster 300. For example, the global controller 312 is configured to track/monitor local frames/phases of respective quantum computer systems where a quantum program is executed; determine relative phases and a phase compensation; communicate the phase compensation to the respective quantum computer systems such that phase coherence on control signals generated and communicated to respective quantum processing units can be maintained. In some implementations, the compiled quantum programs are communicated together with the phase compensation to the control systems 305 of the respective quantum computer systems 303 via transmission links 306. In some implementations, the global controller 312 includes photonic sources, switches, photodetectors, and other optical elements. In some implementations, the transmission links 306 include one or more optical fibers. In some instances, the optical fibers may include one or more single-mode optical fibers, one or more multi-mode optical fibers, or a combination.

In the example shown in FIG. 3A, the signal hardware 304 includes a signal conversion system 308. In some instances, the signal hardware 304 may include other components, for example, signal receiver and signal generator. In some implementations, the signal generator and the signal receiver in the signal hardware 304 can generate signals defined in a first frequency regime. In some instances, the first frequency regime is a mm-wave, terahertz or optical regime, e.g., about 10¹¹-10¹⁶ Hz. In some implementations, the signal hardware 304 may include signaling equipment, which may generate or receive other types of signals including microwave, radio, and electrical signals to various control subsystems in the control system 305. In some implementations, the signal hardware 304 may include additional and different features or components. In some implementations, the signal hardware 304 may be implemented as the signal hardware 104 in the quantum computing unit 103 as shown in FIG. 1. In some implementations, the signal hardware 304 may be adapted in another manner.

In some implementations, the signal conversion system 308 may be configured to receive and convert signals in a first frequency regime to signals defined in a second frequency regime, which can be delivered to quantum circuit devices in the modular quantum processing unit 310. In some implementations, the signals in the second frequency regime may be used to perform quantum processing by operating qubits, readout devices, tunable couplers, or other types of components in the modular quantum processing unit 310. In some implementations, the second frequency regime is a microwave or radio regime, e.g., about 10⁶-10¹⁰ Hz.

In certain instances, the signal conversion system 308 can be integrated with the modular quantum processing unit 310. For example, the signal conversion system can be fabricated on a substrate (e.g., the substrate 244 in FIG. 2C) supporting the quantum processor chips. For another example, the signal conversion system 308 can be fabricated on the same substrate as the quantum processor chip (e.g., the quantum processor chip 242 in FIG. 2C). In some instances, the signal conversion system 308 can be integrated with the modular quantum processing unit 310 in another manner.

In some implementations, the signal conversion system 308 includes an optical detector system. For example, a signal conversion system 308 includes optical components such as photodetectors, optical couplers, and optical waveguides. The optical coupler can be optically coupled to the transmission links 306. A photodetector may be configured to detect the signals in the first frequency regime and to convert the signals in the first frequency regime to signals in the second frequency regime. A photodetector may include an array of photodiodes, e.g., a Charge Coupled Device (CCD) sensor, a Complementary Metal-Oxide Semiconductor (CMOS) sensor, or any of the other types of photodiodes. A photodetector may output the signals in the second frequency regime for controlling the quantum circuit devices on the modular quantum processing unit 310 via transmission link 307. An optical coupler may be used to enable communication between the transmission links 307 and the photodetector. In some implementations, the signal conversion system may further include other optical elements, including optical interconnect and wavelength selective switches, filters, dispersion compensation elements, attenuators, gain equalizers, isolators, and circulators. In some instances, the signals generated by the photodetector may be amplified and transmitted to the modular quantum processing unit 310 through RF waveguides. An RF waveguide may include one of a co-planar waveguide, a microstrip, or a stripline formed on the same substrate as the quantum processor module or on the same substrate as a cap module or a monolithic cap structure. In some implementations, the RF waveguide may include superconducting materials, metals, or another type of conductive material.

In some implementations, the signal conversion system includes a transducer device. A transducer device can be coupled to the transmission links 306 through an optical coupler. A transducer device can receive signals in the first frequency regime and converts to signals in the second frequency regime. In some implementations, a transducer device in the signal conversion system 308 is a direct electro-optical transducer device. For example, a transducer device includes evanescently coupled optical ring resonators and a superconducting microwave resonator. Each of the optical ring resonators includes a lithium niobate triplet resonator device. The superconducting microwave resonator includes an inductor element and a capacitor element and is configured to modulate the received optical excitation. The coupled optical ring resonators and microwave resonator are used to generate photon pairs. Examples of photon pair generation in parametrically coupled resonators are described in the publication entitled “Non-classical Correlations between Single Photons and Phonons from a Mechanical Oscillator” by Riedinger, et al. (arXiv:1512.05360v2 [quant-ph], Dec. 16, 2015), and in the publication entitled “Cryogenic microwave-to-optical conversion using a triply resonant lithium-niobate-on-sapphire transducer” by T. P. McKenna et al. (arXiv:2005.00897v1 [quant-ph] May 2, 2020)

As shown in the example quantum computer cluster 300 in FIG. 3A, different subsystems of the example quantum computer cluster 300 may operate in different environments. For example, the global controller 312, the local controller 302, part of the signal hardware (e.g., the signal generator and the signal receiver) may operate in a warm temperature environment (e.g., room-temperature environment) outside the dilution refrigerator system. For example, the signal conversion system 308 of the signal hardware 304 and the modular quantum processing unit 310 may operate in a cryogenic environment inside the dilution refrigerator system. In some implementations, the signal conversion system 308 may be integrated with the modular quantum processing unit 310 on a lowest-temperature thermal stage 212D of the dilution refrigerant system 224. In some implementations, the signal conversion system 308 may be configured on a different thermal stage of the cryostat (e.g., the second lowest temperature thermal stage 212C of the dilution refrigerant system 224 in FIG. 2B).

In some implementations, the quantum computer cluster 300 includes multiple global controllers 312 and each global controller 312 may be communicably connected to a subset of quantum computer systems 303. For example, when the quantum computer cluster 300 has a tree topology, a first level global controller may coordinate a subset of the quantum computer systems 303; and a second level global controller may coordinate multiple first level global controllers.

FIG. 3B is a flow chart showing aspects of an example process 330 for maintaining phase coherence of control signals in distinct quantum computer systems in a quantum computer cluster. The example process 330 can be used, for example, to operate a global controller, e.g., the global controller 312 in FIG. 3A. For instance, the example process 330 can be used to coordinating and synchronizing the control signals communicated to respective quantum processing units in respective quantum computer systems. In some instances, the example process 330 can be used to track local frames from the respective quantum computer systems; determine phase compensation for the respective coherently interconnected quantum computer systems when a quantum program is executed. In some implementations, the native quantum program includes at least one multi-qubit quantum logic gate to be executed by qubit devices from distinct coherently interconnected quantum computer systems. The example process 330 may include additional or different operations, including operations performed by additional or different quantum circuit devices, and the operations may be performed in the order shown or in another order.

At 332, local frames are obtained from quantum computer systems. In some implementations, the quantum computer systems are coherently interconnected via coherent interlinks (e.g., the coherent interlinks 320 in FIG. 3A). In some instances, local frames are obtained by each of the quantum computer systems by measuring the state of the qubit devices in the quantum computer system. In some implementations, a local frame is a relative phase of a qubit device with respective to a common reference frame.

At 334, phase compensation is determined based on the local frames. For example, the phase compensation is determined based on a phase difference of the local frames to ensure that the relative phases of the control signals communicated to the qubit devices and the qubits defined by the qubit devices remain constant and remain a coherent state, even as the system evolves over time.

At 336, the determined phase compensation is transmitted to the quantum computer system. In some implementations, a value of the determined phase compensation is implemented as a phase correction to the control signals (e.g., the qubit drive phase of the qubit drive signals).

At 338, the quantum computer systems are caused to adjust phases of control signals according to the phase compensation. The phase corrected control signals are communicated to the qubit devices in the distinct coherently interconnected quantum computer systems to execute the quantum program.

FIG. 4A is a schematic diagram of an example quantum computer cluster 400. The example quantum computer cluster 400 includes multiple coherently linked quantum computer systems 430 via respective coherent interlinks 442. Each quantum computer system 430 includes at least one quantum processor unit 420. In some implementations, each quantum processing unit 420 of a quantum computer system 430 is a modular quantum processing unit including multiple quantum processor chips 410. The quantum computer cluster 400 may include additional or different features, and the components of the quantum computer cluster 400 may operate as described with respect to FIG. 4A or in another manner. For example, although nine quantum computer systems 430 connected in a two-dimensional mesh topology are shown in FIG. 4A, the quantum computer cluster 400 may include more or less quantum computer systems 430; and the quantum computer systems 430 in the quantum computer cluster 400 may be connected in a different manner forming a different topology.

In some implementations, a coherent interlink 442 is configured to entangle a first qubit device from a quantum computer system 430 with a second qubit device from a distinct, coherently interconnected quantum computer system 430, for example, when a multi-qubit quantum logic gate in a quantum program is configured to be applied on qubits defined by the first qubit device and the second qubit device. In some instances, the coherent interlink 442 may be an optical interconnect, a superconducting interconnect, or another type of interconnect. In some instances, the quantum processor chips 410, the quantum processing units 420, the quantum computer systems 430, and the quantum computer clusters 400 may be implemented as the respective quantum processor chips 242, quantum processing units 230, quantum computer systems 202, and quantum computer clusters 200 in FIGS. 2A-2C or in another manner.

In some examples, each quantum processor chip 410 includes superconducting qubit devices in a range of 40 to 100 or more; and the modular quantum processing unit 420 may include a number of quantum processor chips 410 in a range of 16 to 100 or more. Consequently, a quantum computer unit 430 can operate up to ˜10,000 or more qubits, and the quantum computer cluster 400 can operate up to 1,000,000 or more qubits.

For the case shown in FIG. 4A, each modular quantum processing unit 420 hosts a 2-D grid of quantum processor chips 410 with qubit devices and qubit devices of quantum processor chips 410 that reside on the edge of each modular quantum processing unit 420 could be connected to qubit devices on distinct quantum processor chips residing on the edges of distinct modular quantum processing units 420 in the nearest neighbor quantum computer units 430, thus forming a larger 2D grid of qubit devices from all of the quantum computer systems 430 in the quantum computer cluster 400.

In some instances, qubit devices at the edges of each modular quantum processing unit 420 in a quantum computer system 430 are coherently connected to qubit devices at the edges of one or more distinct modular quantum processing units 420 of one or more distinct quantum computer systems 430. In this case, qubit devices at the edges of the modular quantum processing unit 420 may have a higher connectivity than the ones within the modular quantum processing unit 420. For example, if the qubit devices in the modular quantum processing unit 420 has a square lattice with four-fold connectivity, the qubits at the edge of the tile could each have five-fold connectivity, providing three connections to qubit devices within the same modular quantum processing unit (e.g., North, East, South) and two connections to qubit devices within distinct quantum computer systems in the quantum computer cluster, e.g., via respective coherent interlinks 442.

In some instances, qubit devices that are not at the edges of each quantum processing unit 420 in a quantum computer system 430 are coherently connected to qubit devices in one or more distinct quantum processing units 420 of one or more distinct quantum computer systems 430. For example, qubit devices with higher connectivity are scattered throughout a quantum processing unit 420, which may involve some of those extra connections (to other quantum processing units) being taken out in a direction roughly perpendicular to the surface of the quantum processor chip 410, e.g., through the chip substrate or through a cap structure.

As shown in FIG. 4C, the quantum processor chip 410 on the quantum processing unit 420 includes a rectangular array of qubit devices 402A, 402B. The qubit devices 402A, 402B reside on the edge or inside the rectangular array. Each of the qubit devices 402A, 402B are communicably coupled to each other by a coupler device 404B. Each of the qubit devices 402A, 402B may be communicably coupled to other qubit devices on the same quantum processor chip 410 by other respective coupler devices. As shown in FIG. 4C, the qubit devices 404A, 404B may have extra coupler devices 404A, 404C that are coupled to respective coherent interlinks 442A, 442B via a conductive through-hole via 408A in the quantum processor chip 410 and a conductive through-hole vias 408B in the cap wafer 401, respectively. The conductive-through hole via 408A in the cap wafer is galvanically connected to the coupler device 404A through a contact bump 406. In some instances, the conductive-through hole via 408A in the cap wafer may be electrically connected to the coupler device 404A in another manner, e.g., capacitively or inductively. The coherent interlinks 442A, 442B allow coherent interconnection of the qubit devices 402A, 402B to other qubit devices in a distinct quantum computer system. In some instances, the qubit devices 402A, 402B may have more associated coupler devices than other qubit devices on the quantum processor chip, which allow the coupling of the respective coherent interlinks to the qubit devices 402A, 402B via the respective coupler devices 404A, 404C. In some instances, a qubit device may be coupled to a respective coherent interlink in another manner, e.g., through another type of connection.

In some implementations, the coupler devices 404A, 404B 404C may be implemented as fixed-frequency coupler devices, tunable-frequency coupler devices, or other types of coupler devices. In some cases, a coupler device may be a tunable-frequency coupler device. In this case, the coupling between two qubit devices 404A, 404B 404C can be activated or deactivated by tuning the transition frequency of the associated tunable-frequency coupler device. Control signals can be communicated to the qubit devices and the associated tunable-frequency coupler device. In some implementations, associated tunable-frequency coupler devices include those that are in the same layer or between different layers in a three-dimensional lattice. For example, a coupler device may reside on the cap wafer 401.

Avery large range of qubit topologies can be configured, the choice of a particular topology depending on the algorithm to be run. For example, consider the generation of toroidal surfaces. A toroidal surface can be formed by connecting opposite edges of a rectangular array of qubit devices. In some instances, the rectangular array may be made up of a large number of chips across multiple quantum processing units, thus forming a single toroidal surface. In certain instances, each toroidal surface may be generated from a single chip, or a single quantum processing system, and these toroidal surfaces can be connected to other toroidal surfaces, when edge qubit devices have sufficient connectivity, to form nested toroidal surfaces. Using the techniques described above for connecting the qubit devices on chips and connecting the chips on quantum processing units, a multitude of different qubit topologies can be generated.

FIG. 4B is a schematic diagram of the quantum computer system 430 in the example quantum computer cluster 400 shown in FIG. 4A. As shown in FIG. 4B, the quantum computer system 430 includes a cryostat 436 with thermal stages 432, control signal lines and readout lines 434 for operating quantum circuit devices and reading out the state of qubit devices on the modular quantum processing unit 420, and coherent interlinks 442 for coherently connecting qubit devices from a quantum computer system 430 with qubit devices from a distinct quantum computer unit 430. As shown in FIGS. 4A-4B, a quantum computer system residing at the corner of the 2D mesh topology is coherently connected to two other quantum processing systems 430 through two respective coherent interlinks 442; a quantum computer system residing at the edge of the 2D mesh topology is coherently connected to three other quantum processing systems 430 through three respective coherent interlinks 442; and a quantum computer system residing at the inside of the 2D mesh topology is coherently connected to four other quantum processing systems 430 through four respective coherent interlinks 442.

In some instances, the quantum computer cluster 400 includes a global controller; and each quantum computer system 430 of the quantum computer cluster 400 includes a local control system. The global controller and the local control system may be operated as described in FIGS. 2 and 3, or in another manner.

FIG. 5 is a schematic diagram showing aspects of an example quantum computer cluster 500. As shown in FIG. 5, the quantum computer cluster 500 includes multiple quantum computer systems 530 coherently interconnected through multiple coherent interlinks 512. Each quantum computer system 530 is communicably connected to a global controller 506; and includes a control system 508 and a cryostat 510. Each quantum computer system 530 is also connected to an application programing interface 502 for provision of application APIs and services and a quantum error correction (QEC) decoder 504 for receiving error correction data. In embodiments, the QEC decoder 504 may be accessible by the multiple quantum computer system 530 or by the cloud 502. The quantum computer cluster 500 may include additional or different features, and the components of the quantum computer cluster 500 may operate as described with respect to FIG. 5 or in another manner.

As shown in FIG. 5, the control system 510 includes qubit control electronics 522 and qubit state readout electronics 524. The control system 508 of a quantum computer system 530 can be synchronized, phase-corrected, or otherwise controlled by the global controller 506 for coordinated control of all interlinked quantum computer systems 530. In embodiments, the qubit devices are superconducting circuit qubit devices, and the control signals are microwave signals. In some instances, the control system 508 may be implemented as the control system 105, 305 in FIGS. 1 and 3 or in another manner. In some instances, the control system 510 may include other components.

In some implementations, the cryostat 510 includes control signal lines 534 connecting the qubit control electronics 522 of the control system 508 to the modular quantum processing unit 530; the control signal lines 534 are connected to a signal processing unit 528, for example including filters, attenuators, or other devices. The cryostat 510 includes qubit readout signal lines 536 connecting the modular quantum processing unit 530 to the qubit state readout electronics 524. As shown in FIG. 5, the qubit readout signal lines 536 are also connected to the signal processing unit 528, which may include signal amplifiers configured to amplify the readout signals from the modular quantum processing unit 530.

In some implementations, the cryostat 510 further includes a signal conditioning unit 526. In certain examples, the signal conditioning unit 526 can include multiplexing/demultiplexing circuits for control signals and/or read out signals for reduction in the number of signal lines needed. In certain instances, the signal conditioning unit 526 may include other circuit components. For example, the signal conditioning unit 526 can include transducers on signal lines connected to select qubit devices on a modular quantum processing unit 530 in a quantum computer system 530 which are being connected to select qubit devices on a distinct modular quantum processing unit in a distinct quantum computer system 530; the transducers of the signal conditioning unit 526 convert microwave signals to optical signals and vice-versa while maintaining signal coherence for enabling entanglement of between distinct qubit devices of distinct quantum computer systems 530. Optical signals are input/output from the transducers on the coherent interlink 512. In some instances, a coherent interlink 512 can be configured to connect multiple quantum computer systems 530.

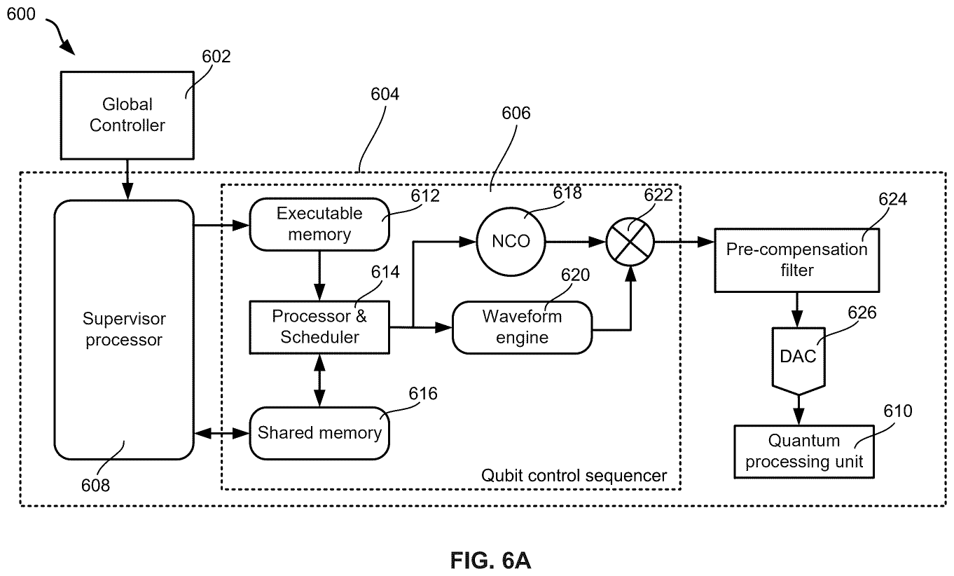

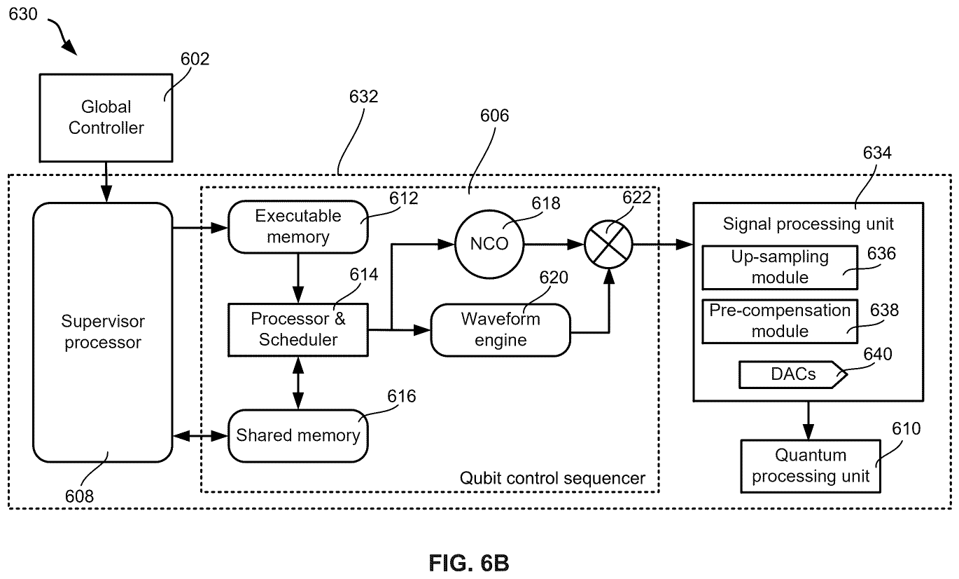

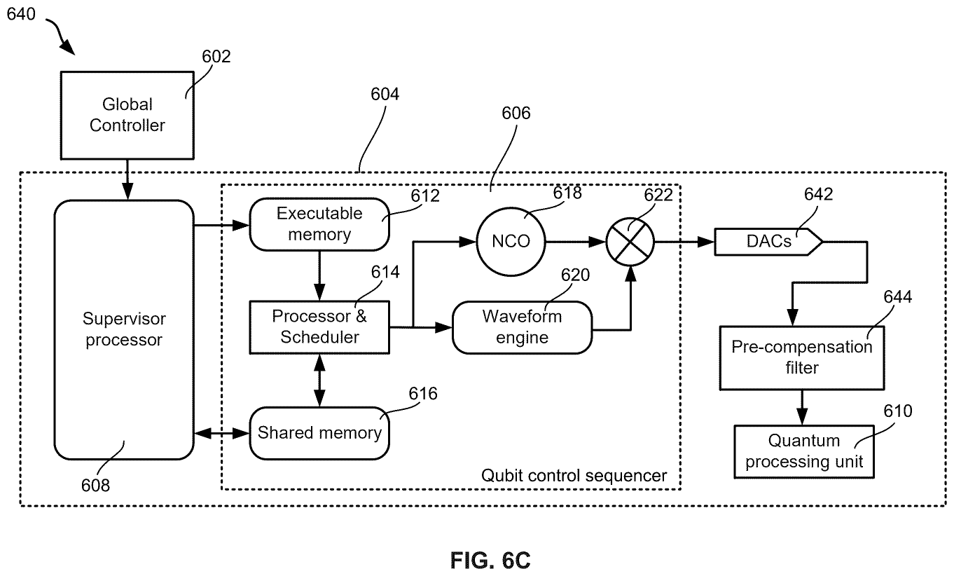

FIG. 6A is a schematic diagram showing aspects of an example quantum computer cluster 600. The quantum computer cluster 600 includes a global controller 602 and a quantum computer system 604. The quantum computer system 630 includes a supervisor processor 608, a qubit control sequencer core 606, a pre-compensation filter 624, a digital-to-analog conversion (DAC) unit 626, and a quantum processing unit 610. The example quantum computer cluster 600 may include additional or different features, and the components of the quantum computer cluster 600 may operate as described with respect to FIG. 6 or in another manner.

In some implementations, the global controller 602 may be implemented as the global controllers 312, 506 in FIGS. 3 and 5 or in another manner, to perform the operations in the example process 330 shown in FIG. 3B. The quantum processing unit 610 may be implemented as the quantum processing unit 102, 230, 310, 420, 530 as shown in FIGS. 1, 2B-2C, 3A, 4A-4B, 5 or in another manner. The supervisor processor 608 is configured to communicate with the global controller 602 to receive a native quantum program, and to perform other functions. In some implementations, the supervisor processor 608 is configured to perform functions including routing data to the qubit control sequencer 606, returning readout data received from readout sequencers (e.g., not shown in FIG. 6, which may have the same basic shape as the qubit control sequencer 606 and is configured to receive data rather than generate pulses) to the global controller 602 and end users, monitoring the state and health of the quantum computer system, or other functions.

In some implementations, the qubit control sequencer 606 is configured to convert a native quantum program to a digital pulse waveform. As shown in FIG. 6A, the qubit control sequencer 606 includes an executable memory unit 612, a processor/scheduler unit 614, a shared memory unit 616, one or more waveform engines 620, one or more numerical controlled oscillator (NCO) devices 618, and a mixer device 622. In some instances, the executable memory unit 612 includes a section of memory that stores the native quantum program that can be executed by the processor/scheduler unit 614. The processor/scheduler unit 614 is configured to determine desired shape and frequency of the waveform envelope to be generated based on the device parameters, control parameters, gate parameters; determine the control signals to be communicated to the waveform engine 620, control the timing and sequence of the control signals; performing a calibration process to adjust the parameters of the control signals, or other functions. In some instances, the processor/scheduler unit 614 includes computing apparatus programmed to perform the aforementioned functions. The shared memory is used to store parameters that change between runs of the same quantum program. The idea is that many quantum algorithms have a fixed structure, applying the same sequence of gates to some set of qubits, but with parameters that change the phase angle or amplitude or frequency of the pulses of some of the gates. You often want to run the same program many times but with different values for these phases/amplitudes/frequencies. So rather than having to recompile your program for each parameter set, you can compile the program with placeholder variable locations that will get fetched from shared memory at run time. Then when you run the program you only have to load the executable and waveform memory one time and then you can run repeatedly by only updating the parameters in the shared memory. The shared memory can also be used to return results from the program, and diagnostic information about how the program ran (for example, which branch was executed if there is a branch instruction that cannot be deterministically determined at compile time).

In some implementations, the NCO unit 618 includes one or more numerically controlled oscillators, each of which can be used to track the frequency and phase of a particular qubit control signal. The processor 614 is configured to communicate with the NCO unit 618 and determine which numerical controlled oscillators to use for mixing in the mixer 622. In some instances, the processor 614 can dynamically adjust the phase and frequency of the NCOs, e.g., for example, when implementing a phase shift received from the global controller 602 during operations in the example process 330 in FIG. 3B. The mixer device 622 is a multiplier configured to perform a digital multiplication. For example, when the waveform envelope from the waveform engine 620 and the NCO output are treated as complex numbers to more easily represent phase shifts, the mixer 622 is a complex multiplier. The resulting complex waveform can be either used directly for baseband signals with no further upconversion by taking the real part of the resulting complex waveform, or it can be further upconverted with a digital or analog mixer. In some instances, the additional upconversion may be performed by operation of the DAC 626. In some instances, the pre-compensation filter 624 has one or more coefficients that can be set dynamically at run-time are desired. For example, a pre-compensation filter 624 may include an infinite impulse response (IIR) filter, a finite impulse response (FIR) filter, or other types of filters. In some instances, the pre-compensation filter 624 in FIG. 6A may be a digital pre-compensation filter.

In some implementations, a waveform envelope is generated using the processor/scheduler unit 614 and the waveform engine 620. These would implement one or more numerically controlled oscillators (NCOs) 618 to track the phase/frequency of various resonances, such as the f01 frequency of the qubit devices or the frame of a parametric two-qubit quantum logic gate. The waveform engine 620 includes dynamically configurable memory to store various waveform envelopes. The scheduler 614 is configured to play a waveform envelope starting at a specified index for a given duration and optionally modulate it using the output of one of the NCOs 618. In some instances, the qubit control sequencer 606 includes multiple waveform engines; and outputs of the multiple waveform engines 620 can be summed together to generate multiplexed signals, or to generate bichromatic signals. A scheduler 614 can also cause multiple NCOs 618 to be summed to modulate a given waveform envelope as another mechanism for generating bichromatic pulses.

As shown in FIG. 6C, a digital pulse waveform may be converted by a DAC unit 626 first, prior to being processed by a pre-compensation filter 624. In this case, the pre-compensation filter 624 is an analog pre-compensation filter. Both the digital pulse waveform and the analog pulse waveform have a low bandwidth. In some instances, the pre-compensation filter 624 resides on a separate control chip and is configured to shape the analog pulse waveform before it is passed to the qubit devices in the quantum processing unit. The pre-compensation filter 624 is configured to account for a transfer function between the local control system and a respective qubit device of a quantum computer system. The pre-compensation filter 624 can be re-programmed in real time to account for drifts in the transfer function.

In some instances, output of the qubit control sequencer 606 includes a digital pulse waveform at a high sample rate (e.g., 2 Gsps or another value). The digital pulse waveform is further processed, including pulse-shaped using the pre-compensation filter 624 and converted to an analog pulse waveform using the DAC unit 626 prior to communicating it to the quantum processing unit.

FIG. 6B is a schematic diagram showing aspects of an example quantum computer cluster 630. The quantum computer cluster 630 includes a global controller 602 and a quantum computer system 632. The quantum computer system 632 includes a supervisor processor 608, a qubit control sequencer core 606, a signal processing unit 634, and a quantum processing unit 610. In some implementations, the global controller 602, the supervisor processor 608, the qubit control sequencer 606, and the quantum processing unit 610 may be implemented and operated as the respective components in FIG. 6A. The example quantum computer cluster 630 may include additional or different features, and the components of the quantum computer cluster 630 may operate as described with respect to FIG. 6 or in another manner.

In some implementations, the signal processing unit 634 is configured to provide functions, including receiving a digital pulse waveform at a relatively low sample rate (e.g., 100-200 Mega sample per second (Msps)) per control signal over a high bandwidth link (e.g., JESD204); up-sampling of the digital pulse waveform to increase its sample rate, digital pre-compensation filtering of the digital pulse waveform, performing high speed digital-to-analog conversion; or other functions. The methods and systems presented here provide a large number of control signals on a single control chip which can reduce bandwidth and simplify data exchange between a qubit control sequencer 606 and the quantum processing unit 610. The methods and systems presented here can overcome or reduce the 10 bottleneck by reducing the digital bandwidth between the chip carrying the qubit control sequencer 606 and the chip carrying the signal processing unit 634.

In some instances, the qubit control sequencer 606 and the signal processing unit 634 may reside on separate chips. In some implementations, the qubit control sequencer core 606 resides on a first control chip; and the signal processing unit 634 resides on a second, distinct control chip. In some implementations, certain components of the qubit control sequencer 606 may reside with components of the signal processing unit 634 on the same chip. For example, the signal processing unit 634 may include the waveform engine 620 without the scheduler 614; may include the waveform engine 620 and the scheduler 614; or it may also include the processor to drive the scheduler 614. In some instances, components of the qubit control sequencer 606 may reside on the signal processing unit 634. For example, the signal processing unit 634 may also include waveform engines 620 and schedulers 614, which may require around 50 Mbps per control line assuming fast gates, 200 control signals, and an input interface at ˜100 Gbit/s. In some instances, the signal processing unit 634 may also include some programmable processor or other configurable logic to produce pulse sequences with conditional logic to implement stabilizers or small surface codes. In some instances, the signal processing unit 634 may be configured to interface with more than 100, 500, 1,000 or another number of control signals.

In some implementations, the data rate required to drive the schedulers 614 can be estimated as one gate every 20 ns (e.g., 50 Mega gate per second) on each control signal (more likely one 10 ns gate on every other control signal). If each gate is represented with roughly one byte, for example, assuming simple compressed representation, indicating which NCO 618 to be used, which waveform, etc., this results in 50 Mbps per control signal. In the case that the scheduler 614, the waveform engines 620, and the signal processing unit 634 are included on the same chip, such chip may intake 50 Mbps per control signal. When 1000 control signals are provided to this chip, that is 50 Gbps˜5×100 GbE links.

In some instances, low level routines, e.g., local stabilizer codes, small surface codes, or other error correction codes, may be processed by the signal processing unit 634. In this case, the signal processing unit 634 may receive higher level operations on a stabilizer or a subset of a logical qubit. The instruction rate is 10-1000 times lower. This means only 5×10 GbE down to as low as 50 Mega instruction per second. Those higher-level instructions would need to be provided by a controller at the next level in the hierarchy. This is potentially where one logical qubit would be formed from a set of these stabilizers, so the decoders needed at this level are more complicated so would likely be their own ASIC/FPGA designed to perform these perfect matching algorithms, etc. For two-qubit quantum logic gates and lattice surgery, additional bandwidth between the controller/decoder and the scheduler/DAC devices may be required.

In some implementations, the signal processing unit 634 on a separate chip is configured to implement a large number of control signals. In some instances, the signal processing unit 634 may include a Radiofrequency system-on-chip (RF SoC) chip, Application-specific integrated circuits (ASICs), and other types of chips. In some implementations, the signal processing unit 634 includes an up-sampling module 636 configured to increase a sample rate of a digital pulse waveform received from the qubit control sequencer 606, a pre-compensation module 638 configured to pulse-shaping the up-sampled digital pulse waveform, and a DAC unit 640 including multiple DAC devices configured for converting the pulse-shaped digital pulse waveform into an analog pulse waveform. In some instances, the signal processing unit 634 includes other devices or components, e.g., RF front ends, etc. In some instances, the signal processing unit 634 may be driven by a large data rate (e.g., at least 100 Mbps per control signal or another value). In this case, the signal processing unit 634 may be communicably coupled to 30 control lines, 100 control lines, or another numbers of control lines. In some instances, the pre-compensation module 638 includes pre-compensation filters which are tunable in real time to account for changes in the transmission function between the qubit control sequencer 606 and other control electronics at an elevated temperature (e.g., room temperature) and the quantum processing unit residing at a cryogenic environment. The pre-compensation filter is configured to account for a transfer function between the local control system and a respective qubit device of a quantum computer system. The pre-compensation filter can be re-programmed in real time to account for drifts in the transfer function. For example, one or more coefficient of the pre-compensation filter can be re-programmed in real time to account for drifts in the transfer function.

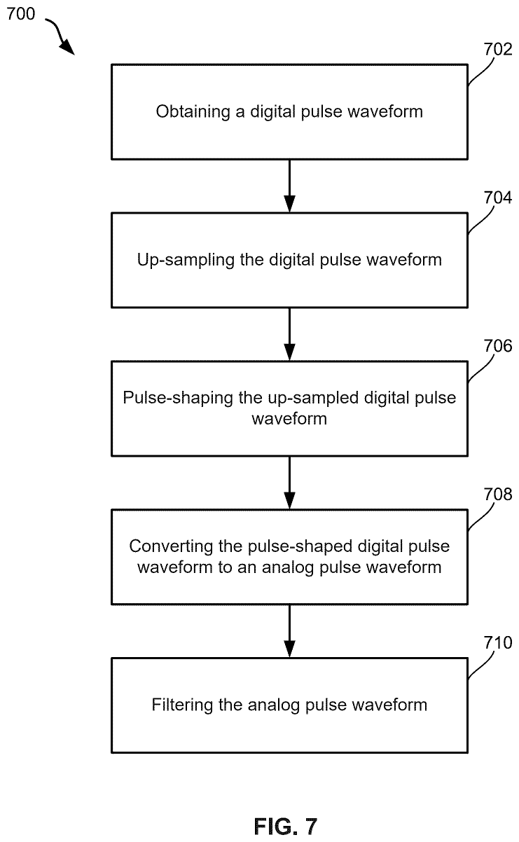

FIG. 7 is a flow chart showing aspects of an example process 700 for conditioning control signals communicated to a quantum processing unit in a quantum computer system. The example process 700 can be used, for example, to operate a signal processing unit, e.g., the example signal processing unit 634 in FIG. 6B. For instances, the example process 700 can be used to perform up-sampling and pulse-shaping operations on a digital pulse waveform and converting the digital pulse waveform to an analog pulse waveform which includes analog control signals that can be communicated for a quantum processing unit. In some instances, the example process 700 can be used to receive at a bandwidth more tailored to the information content of desired pulses at the qubit devices (e.g., at 200 Msps); increase the sample rate of the control signals; improve communication efficiency of control signals to the quantum processing unit when a quantum program is executed; and eliminate the communication bottleneck from the input/output interface between the qubit control sequencer 606 and the quantum processing unit 610. The example process 700 may include additional or different operations, including operations performed by additional or different quantum circuit devices, and the operations may be performed in the order shown or in another order.

In some implementations, one or more operations in the example process 700 can be performed by a computer system, for instance, by a digital computer system having one or more digital processors (e.g., a microprocessor or other data processing apparatus) that execute instructions (e.g., instructions stored in a digital memory or other computer-readable medium), or by another type of digital, quantum or hybrid computer system. As an example, in some cases the quantum processing unit can be deployed as the quantum processing unit 102, 230, 310, 420, 530 shown in FIGS. 1, 2B-2C, 3, 4A, 5, and operations in the example process 700 shown in FIG. 7 can be initiated, executed, or controlled by one or more components of the quantum computer system 103, 632 shown in FIGS. 1 and 6B.

At 702, a digital pulse waveform is obtained. In some implementations, a digital pulse waveform is generated by translating a sequence of native quantum logic gates in a native quantum program. In some instances, a native quantum program can be obtained by performing a compilation operation on a quantum program received from a user (e.g., a user program). A sequence of quantum logic gates in the quantum program before compilation can be converted to the sequence of native quantum logic gates in the native quantum program after compilation. In some instances, the sequence of native quantum logic gates can be applied on qubits defined by qubit devices in the quantum processing unit.

In some implementations, a quantum program can be represented, for example, as a quantum Hamiltonian, a sequence of quantum logic gates, a set of quantum machine instructions, or otherwise. The quantum program may correspond to a computational task, a hardware test, a quantum error correction procedure, a quantum state distillation procedure, or a combination of these and other types of operations. In some instances, a quantum program includes a first sequence of quantum logic gates, e.g., single-qubit quantum logic gates, two-qubit quantum logic gates, multi-qubit quantum logic gates, identity gates, and other quantum logic gates. In some instances, the quantum program can be an Quil program generated by a user device (e.g., the user device 110 as shown in FIG. 1), another computer resource outside the local environment of the quantum computer system 103, or in another manner; and received by a quantum computing system (e.g., the control system 105 of the quantum computing system 103 in FIG. 1).

In some implementations, the received quantum program is compiled according to the quantum computer system or multiple quantum computer systems that are coherently interconnected through coherent interlinks where the quantum program is to be executed. In this case, after compilation, the quantum program includes quantum logic gates that can be executed on quantum circuit devices (e.g., qubit devices and associated coupler devices) in a quantum processing unit. In some implementations, the quantum program can be compiled by operation of a compiler after receiving the quantum program.

In some instances, a native gate set includes a set of quantum logic gates that can be directly executed by the quantum processing unit. After a native gate set for the quantum processing unit is identified, a quantum logic gate in the first sequence of quantum logic gates (e.g., one or more parametric quantum logic gates) in the quantum program can be converted, translated, or otherwise compiled into a native gate sequence in a second sequence of quantum logic gates. Each of the native quantum logic gates in a native gate sequence may be a parametric single-qubit rotation gate, a parametric two-qubit quantum logic gate, a parametric three-qubit quantum logic gate, or another quantum logic gate. In addition to the parametric quantum logic gates, a native gate set may include one or more non-parametric quantum logic gates. For example, a two-qubit quantum logic gate, e.g., CNOT gate, in a received quantum program from a user can be decomposed into several iSWAP gates or a CZ gate that can be directly executed on quantum circuit devices in a quantum processing unit.

When the quantum program before compilation includes more than one quantum logic gates, more than one native gate sequences can be formed, e.g., by parametric decomposition or in another manner. Generally, the one or more native gate sequences are quantum-logically equivalent to the respective one or more quantum logic gates in the quantum program before compilation.

In some instances, the quantum program after compilation can be further improved. For example, the second sequence of quantum logic gates can be rearranged to reduce count of native quantum logic gates (e.g., gate counts), reduce parallel circuit depth, time steps, and other quantum logic circuit parameters to reduce run time or improve another performance.

In some implementations, a calibration process is performed. In some implementations, a calibration process is performed to determine control parameters of control signals for executing the sequence of native quantum logic gates on the quantum processing unit in a single quantum computer system or the coherently interconnected quantum processing units in distinct quantum computer systems within the quantum computer cluster.

In some instances, device parameters of the designated quantum circuit devices where the native quantum program is executed are obtained. In some implementations, the device parameters of the qubit devices and tunable-frequency coupler devices in the quantum processing units in the quantum computer systems of the quantum computer cluster are determined by performing a measurement or characterization process, a tune-up process, or another type of calibration process. In some instances, a measurement process can characterize a particular set of quantum circuit devices in the quantum processing units for performing the native quantum program. In some instances, the device parameters may be predetermined using another process, which then can be stored and obtained in another manner. For example, a measurement process can be executed to characterize all the quantum circuit devices in the quantum processing units of the quantum computer cluster to obtain the device parameters of each of the qubit devices and coupler devices in a device array, for example, once a quantum processing unit is cooled down.

In some instances, device parameters that can be used to characterize a tunable-frequency qubit device include a tunable range of transition frequencies. In certain examples, a tunable range of transition frequencies is defined by a maximal frequency value, e.g., the |0>→|1> transition frequency value at a magnetic flux of zero flux quantum applied to the tunable-frequency qubit device,

$${ω}_{01} ( Φ = 0 ) ≡ {ω}_{01}^{max} \qquad ( 1 )$$

and a minimum frequency value, e.g., the |0 [symbol] →|1 [symbol] transition frequency value at a magnetic flux of half-flux quantum,

$${ω}_{01} ( Φ = \frac{{Φ}_{0}}{2} ) ≡ {ω}_{01}^{min} \qquad ( 2 )$$

anharmonicity at the magnetic flux of zero flux quantum,

$$η ( Φ = 0 ) ≡ {η}_{}^{max} \qquad ( 3 )$$

and the qubit flux bias Φ, e.g.,

$$Q = Q ( {ω}_{01}^{max} , {ω}_{01}^{min} , {η}_{}^{max} , Φ ) \qquad ( 4 )$$

where Q represents a collection of device parameters that can be used to describe a qubit device. In some implementations, a maximal frequency value may be at a different magnetic flux. For example, a maximal frequency value may be at a value offset from a magnetic flux of zero flux quantum, a magnetic flux of half flux quantum, or another value.

In some implementations, the device parameters may include one or more of the device parameters of the tunable-frequency qubit device in the quantum processing unit. For example, device parameters, such as a maximum transition frequency

$${ω}_{12}^{max} ,$$

and the anharmonicity (η) at

$${ω}_{12}^{max} ,$$

can be used to characterize the qubit implementation beyond the lowest two states. In some instances, device parameters further include periodicity, coupling strengths, and other device parameters can be calibrated, measured, and stored, e.g., in a database of the memory 112 of the server 108. In certain instances, circuit parameters of circuit components in an equivalent circuit representing quantum circuit devices in the quantum processing unit can be calculated based on the device parameters.

In some examples, the transition frequency of a tunable-frequency qubit device or a tunable-frequency coupler device from the ground state |0> to the first excited state |1> is measured by using qubit spectroscopy. Ramsey interferometry can then be used to fine tune the value of the transition frequency obtained from the spectroscopic measurement. In some instances, the transition frequency can be measured at one or more reference values of the applied magnetic flux. For example, the transition frequency of a tunable-frequency qubit device can be measured at zero flux and one-half flux quantum; the tunable-frequency qubit devices may be measured under other flux conditions.

In some examples, after the transition frequencies of the tunable-frequency qubit device are obtained, qubit spectroscopy can be used to measure the transition frequency from the ground state |0> to the second excited state |2> which can be used to calculate the anharmonicity of the tunable-frequency qubit device. For instance, the absolute value of the anharmonicity of a tunable-frequency qubit device may be computed as |η|=|2ω₀₁-ω₀₂|, where ω₀₁ represents the transition frequency from the ground state |0> to the first excited state |1 [symbol] of the tunable-frequency qubit device, and ω₀₂ represents the transition frequency from the ground state |0> to the second excited state |2> of the tunable-frequency qubit device.

In some implementations, a control signal includes a flux bias signal that can be communicated to the tunable-frequency qubit device on a flux bias control line to tune the transition frequency. In some implementations, a control signal includes a flux modulation signal which can be communicated to the tunable-frequency qubit device on a flux bias control line to modulate the transition frequency. In certain instances, the control signal also includes a qubit drive signal which can be communicated to the tunable-frequency qubit device on a distinct qubit drive control line to activate a single-qubit quantum logic gate. In certain instances, control signals, such as flux modulation signal and qubit drive signal, may be communicated to a qubit device on a common control line which is inductively and capacitively coupled to the qubit device. Control signals (e.g., a flux bias signal, a flux modulation signal, a qubit drive signal, or another type of control signal) can be characterized by control parameters of the control signals including modulation parameters such as a DC flux bias Φ_{d}, a flux modulation amplitude Φ_{ac}, a flux modulation frequency fₘ, a modulation phase θₘ, and drive parameters, such as a drive amplitude Ω_{d}, a drive frequency f_{d}, and a drive phase θ_{d}. In certain examples, the device parameters obtained from the device measurement process can be used to determine initial values of the control parameters of the control signals that can be applied to the respective quantum circuit devices, e.g., to activate a coupling between two qubit devices by tuning the coupler flux bias from a parking value to a gate-activating value, to deactivate a coupling between two qubit devices by tuning the coupler flux bias from a gate-activating value to a parking value, to bring two qubit devices into resonance for a precise time period, and to perform other functions.

In some implementations, control parameters of control signals to execute the native quantum program are determined. In some implementations, a calibration process is performed on quantum circuit devices of a quantum processing unit. In some implementations, a calibration process is performed to determine optimal values of the control parameters of the control signals for executing the native quantum logic gates and other control operations when the native quantum program is executed. In some instances, a calibration process is or includes an objective optimization process with an optimization objective to maximize performance. For example, an optimization objective in a calibration process may include maximizing gate fidelity, or other optimization objectives. In some implementations, a calibration process may be a gate optimization process with multiple objectives.

For example, the control system of the quantum computing system generates calibration signals, and the calibration signals are delivered to the quantum processing units of the quantum computer systems. The calibration signals can include, for example, microwave pulses applied to individual circuit devices (e.g., qubit devices), flux bias signals applied to individual coupler devices (e.g., tunable-frequency coupler devices), or other types of signals. The control system then obtains calibration measurements from the quantum processing unit, and the control system uses the calibration measurements to determine the control parameters. For instance, in the quantum computing system 103A shown in FIG. 1, the controllers 106A can identify calibration signals that are configured to execute a pre-defined calibration routine, and the calibration signals can then be generated by the signal hardware 104A and delivered to devices (e.g., qubit devices) in the quantum processing unit 102A. The pre-defined calibration routine can include, for example, the types of experiments, measurements, processes, optimization criteria or other features described in U.S. Pat. No. 10,282,675 entitled “Performing a Calibration Process in a Quantum Computing System;” other types of calibration routines may be used in some cases. During the calibration process, the control system 105A obtains calibration measurements from the quantum processing unit 102A and uses the calibration measurements in the calibration routine, for instance, to identify an improved or optimal value of one or more control parameters. The calibration measurements may include readout signals from resonator devices or other types of measurements obtained from the quantum processing unit 104A. The control parameters that are modified based on the calibration measurements can include, for example, the amplitude (power), frequency, duration, or phase of a microwave pulse; the amplitude (power), frequency, duration, or phase of a flux bias signal; or other types of control parameters for control signals.

In some implementations, calibration signals are generated (e.g., by operation of the control system 630 in FIG. 6) according to values of the control parameters (e.g., the initial values of the control parameters determined based on the device parameters or the improved values determined during the calibration process) and delivered to respective quantum circuit devices of the quantum processing unit (e.g., the qubit devices where native quantum logic gates are executed, and the coupler devices). In order to perform a calibration measurement, calibration signals are communicated to respective quantum circuit devices to perform operations on the respective quantum circuit devices, e.g., tuning the effective coupling strength between two qubit devices, tunning effective coupling between a qubit device and a coherent interlink, tuning the transition frequency of a tunable-frequency qubit devices, and other operations. In some implementations, results of the calibration measurements are obtained from the quantum processing unit. For example, improved values of the control parameters of the calibration signals communicated to the respective quantum circuit devices, when the operations within the same augmented group are executed in parallel, can be determined.

In some cases, the calibration process may include a continuous-wave (CW) characterization procedure, which may include cavity spectroscopy measurements, qubit spectroscopy measurements, T1 and T2 measurements, and others. In some cases, the calibration process can include a pulsed characterization procedure, which may include cavity spectroscopy measurements, Rabi spectroscopy measurements, Ramsey spectroscopy measurements, power Rabi measurements, T1 and T2 measurements, and others. The CW or pulsed characterization procedures may perform measurements to detect the quality factor, resonance frequency, Lamb shift and other parameters of a device.

In some cases, the calibration process performed includes a gate tune-up procedure. For example, the gate tune-up procedure may include optimization of readout pulses or parameters, AC Stark coefficient measurements, pi-pulse amplitude tune-ups, Derivative Removal by Adiabatic Gate (DRAG) tune-ups, randomized benchmarking, other types of benchmarking, and others. The gate tune-up may include measurement of coupling strengths between qubit devices, characterization of tuning pulses for tunable-frequency qubit devices, and other types of measurements. In some cases, the calibration process performed includes a tune-up of multi-qubit quantum logic gates, single-qubit quantum logic gates, benchmarking procedures, or other types of processes.

In some cases, the calibration process performed may include a tune-up procedure for parametrically-activated two-qubit quantum logic gates. The parametrically-activated two-qubit quantum logic gate can be a quantum logic gate applied to a pair of qubits, where at least one of the qubits is defined on a tunable-frequency qubit device. The parametrically-activated two-qubit gate can be performed by modulating the resonance frequency of the tunable-frequency qubit device. The tune-up procedure can include, for example, characterizing both qubits, calibrating the flux drive line transfer function, determining a good candidate resonance for coupling, determining an amplitude for flux modulation, performing a multidimensional modulated flux pulse measurement, optimizing over pulse parameters, and other types of operations.

In some implementations, local frame/phases of respective quantum computer systems are obtained by the global controller 602 from respective quantum computer systems 630. The local frames/phases are used by the global controller to determine relative phase and a phase compensation when a multi-qubit quantum logic gate is applied to qubit devices from distinct quantum computer systems that have different local frames/phases. Values of the phase compensation can be communicated back to the quantum computer systems 632 from the global controller 602 and used to correct control parameters (e.g., the qubit drive phases of qubit drive signals).

In some implementations, by operation of the waveform engine 620 of the qubit control sequencer 606, a waveform envelop is generated or obtained. In some instances, the schedulers 614 may receive waveform instructions from one or more programmable processors implemented in fixed logic on the same chip; from processors on another chip; from a network or other connection bringing the data from some other central processor; from configurable logic on the chip that could implement processors or some other data manipulation hardware to take higher level instructions and convert them to low level pulses using pre-configured calibrations. In some implementations, the numerical controlled oscillator 618 is configured to generate an oscillation signal. In some implementations, the scheduler 614 is configured to determine modulation frequency and phase settings of the numerical controlled oscillator 618.

In some implementations, the waveform envelope from the waveform engine 620 is upconverted based on the oscillation signal from the numerical controlled oscillator 618. The digital pulse waveform from the output of the mixer device 622 includes a control signal with amplitude, phase, and frequency modulation. Thus, by operation of the qubit control sequencer 606, the desired gate sequence in the quantum program is translated into a sequence of numerical values representing the desired frequency and phase of the microwave signal at each time step. In some instances, amplitude and phase modulation can be used to adjust the shape and timing of the microwave signal, to optimize the pulse sequence for high-fidelity gate operations. In some instances, the digital pulse waveform is a sinusoidal signal with a frequency and phase that varies over time or other types of microwave signals according to the desired gate operation. In some implementations, the sample rate of the digital pulse waveform is in a range of 100-200 Mbyte per second (Mbps), or another range.

In some instances, a calibration process also includes measuring the response of the qubit devices to the microwave pulses and adjusting the pulse parameters of the numerical controlled oscillator 618 to maximize the fidelity of the gate operation. In this case, the timing or amplitude of the pulses can be controlled and varied; additional compensation to the pulses can be added to account for specific imperfections in the hardware; and other operations may be performed. For example, randomized benchmarking or gate set tomography can be used for the precise characterization of the gate operation and the identification of sources of error.

At 704, the digital pulse waveform is up-sampled. In some implementations, by operation of the up-sampling module 636 of the signal processing unit 634, the sample rate of the digital pulse waveform received from the qubit control sequencer 606 is increased by inserting additional samples in the digital pulse waveform. In some implementations, inserting additional samples between the existing samples in the digital pulse waveform is performed by interpolation. For example, a mathematical algorithm can be used to estimate values of new samples based on values of existing samples in the digital pulse waveform. In some instances, the mathematical algorithm for interpolation includes a linear interpolation. In some implementations, the sample rate of the digital pulse waveform can be increased to 2 Gsps or another value. In some instances, up-sampling is a process of zero-padding a time-series. Up-sampling by M increases the number of samples by M through inserting M−1 zero samples after each input sample.

At 706, the up-sampled digital pulse waveform is pulse shaped. In some implementations, a pulse-shaping process is configured to compensate for frequency-dependent distortion introduced by microwave hardware, such as non-linearities in the microwave amplifier or distortion in the transmission line; and improve the fidelity of gate operations in the quantum processing unit. In some instances, a pulse-shaping process includes spectral filtering or digital pre-distortion. In some implementations, the pulse shaping process includes a pre-compensation filtering operation by applying one or more filters to the digital pulse waveform received before communicating it to the quantum processing unit. In some implementations, run-time configurable distortion can be compensated using one or more pre-compensation filters, such as infinite impulse response (IIR) filters, finite impulse response (FIR) filters, or other types of filters.

In some implementations, an IIR filter is a type of digital filter that uses feedback to produce a response to a given input signal. An IIR filter is characterized by having a non-linear phase response, which can introduce additional distortion in the digital pulse waveform. In some implementations, an FIR filter is a type of digital filter that uses a finite number of coefficients to produce a response to a given input signal. This filter is characterized by having a linear phase response, which can result in less distortion in the digital pulse waveform than IIR filters. In some instances, types of filters can be determined based on the specific characteristics of the hardware and the desired digital pulse waveform. In some instances, the up-sampled digital waveform can be pulse-shaped in another manner.

At 708, the pulse-shaped digital pulse waveform is converted to an analog pulse waveform. In some implementations, the pulse-shaped digital pulse waveform is converted to the analog pulse waveform by operation of the digital-to-analog (DAC) units 640 of the signal processing unit 634 in FIG. 6B, for example by transforming the discrete digital samples of the digital pulse waveform into a continuous analog signal. The DAC units 640 may be operated at a resolution and a sample rate, which determines the accuracy and fidelity of the converted analog pulse waveform. In some instances, the analog pulse waveform may be further amplified by operation of an analog signal amplifier.

At 710, the analog pulse waveform is filtered. In some implementations, the analog pulse waveform is filtered using an analog filter to remove any un-wanted components that may cause distortion or interference in the qubit devices. For example, a low-pass filter, a band-pass filter, or other types of filters may be used. When the high-frequency components are not removed before the analog pulse waveform is fed into the microwave hardware, they can create aliasing effects that can cause distortion and interference in the qubit devices of the quantum processing unit. In some implementations, an anti-aliasing filter is configured to remove these high-frequency components and ensure that the analog pulse waveform accurately represents the original digital pulse waveform. In some implementations, after applying the anti-aliasing filtering to the analog pulse waveform, the filtered analog pulse waveform (e.g., analog control signals) may be directly communicated to the quantum processing unit in the cryostat via a transmission line or in another manner.

FIGS. 8A-8D are schematic diagrams showing aspects of quantum computer clusters with quantum computer systems coherently interconnected in various topologies. In particular, FIG. 8A is a schematic diagram showing a quantum computer cluster 800 with a ring topology; FIG. 8B is a schematic diagram showing a quantum computer cluster 810 with a start topology; FIG. 8C is a schematic diagram showing a quantum computer cluster 820 with a mesh topology; FIG. 8D is a schematic diagram showing a quantum computer cluster 830 with a tree topology. FIG. 8E is a schematic diagram showing a quantum computer cluster 840 with a two-dimensional rectilinear array topology. FIG. 8F is a schematic diagram showing a quantum computer cluster 850 with a three-dimensional cubic array topology. Each of the quantum computer clusters 800, 810, 820, 830, 840, 850 includes multiple quantum computer systems 802 with respective coherent interlinks 804 in the X-Y plane. Quantum computer systems 802 are housed in distinct cryostats. The quantum computer cluster 850 also includes quantum computer systems 802 in multiple X-Y planes. Quantum computer systems 802 from different X-Y planes are coherently interconnected via respective coherent interlinks 806 along the Z axis. The quantum computer cluster 850 of FIG. 8F is shown with only five coherent interlinks 806 for purposes of clear illustration; however, the quantum computer cluster 850 may include any number of coherent interlinks 806.

In a general aspect, a quantum computer cluster for large scale application is presented.

In a first example, a quantum computer cluster including a global controller, a first quantum computer system including a first qubit device, and a second quantum computer system including a second qubit device. Each of the first and second quantum computer systems are communicably connected to the global controller. The first and second quantum computer systems include respective quantum processing units housed in distinct cryostats, the method for operating the global controller of the computer cluster includes obtaining respective local frames from the first and second quantum computer systems; determining respective values of phase compensation for the first and second quantum computer systems based on the respective local frames; transmitting the respective values of the phase compensation to the first and second quantum computer systems; and causing the first and second quantum computer systems to apply phase shifts to phases of control signals communicated to at least one of the first and second qubit devices according to the respective values of the phase compensation received from the global controller.

Implementations of the first example may include one or more of the following features. The first and second quantum computer systems include respective local control systems communicably coupled to the respective quantum processing units and the global controller. Obtaining the respective local frames from the first and second quantum computer systems includes obtaining the respective local frames from the respective local control systems of the first and second quantum computer systems. Obtaining the respective local frames from the first and second quantum computer system includes obtaining a first local frame from the first quantum computer system; and obtaining a second local frame from the second quantum computer system. The first local frame indicative to a first relative phase of the first qubit device with respect to a first reference frame; and the second local frame indicative to a second relative phase of the second qubit device with respective a second reference frame. The first reference frame is distinct from the second reference frame. The first and second reference frames are the same and are obtained from a common reference frame. The first and second local frames are determined by operation of the respective local control systems of the first and second quantum computer systems.

Implementations of the first example may include one or more of the following features. Applying the phase shifts includes by operation of the respective local control system, shifting a first qubit drive phase of a first qubit drive signal communicated to the first qubit device in the first quantum computer system according to a first value of the phase compensation; and shifting a second qubit drive phase of a second qubit drive signal communicated to the second qubit device in the second quantum computer system according to a second value of the phase compensation.

Implementations of the first example may include one or more of the following features. The respective quantum processing units of the first and second quantum computer systems are interconnected via a coherent interlink configured to create entanglement between the first and second qubit devices. The coherent interlink is an optical coherent interlink. The respective local control systems include respective signal conversion units. The first and second qubit devices are interconnected via the respective signal conversion units and the coherent interlink. The coherent interlink is a superconducting coherent interlink including a transmission line. The first and second qubit devices are coupled to the transmission line via a tunable-frequency coupler device.

Implementations of the first example may include one or more of the following features. The method includes communicating the phase shifted control signals to a respective qubit device. Communicating the phase shifted control signals to the respective qubit device includes obtaining a digital pulse waveform; converting the digital pulse waveform to an analog pulse waveform; and communicating the analog pulse waveform to the respective qubit device. Obtaining the digital pulse waveform includes applying a phase shift to the digital pulse waveform. Obtaining the digital pulse waveform includes generating the digital pulse waveform by operation of a first control chip; and communicating the digital pulse waveform from the first chip to a second, distinct control chip. The first value is in a range of 100-200 mega samples per second (Msps), and the second value is two giga samples per second (Gsps). Up-sampling the digital pulse waveform includes up-sampling the digital pulse waveform by performing an interpolation process. The method includes after up-sampling the digital pulse waveform, pulse-shaping the up-sampled digital pulse waveform.

Implementations of the first example may include one or more of the following features. The method includes reducing a bandwidth between the first and second control chips. Reducing the bandwidth between the first and second control chips includes up-sampling the digital pulse waveform to increase a sample rate of the digital pulse waveform from a first value to a second value. Pulse-shaping the up-sampled digital pulse waveform includes applying a pre-compensation filter to the up-sampled digital pulse waveform. The pre-compensation filter is configured to account for a transfer function between the local control system and a respective qubit device of a quantum computer system. The pre-compensation filter is configured to operate at the sample rate of the second value. In response to a drift in the transfer function being detected, the method includes re-programming one or more coefficient of the pre-compensation filter. Converting the digital pulse waveform to the analog pulse waveform includes converting the digital pulse waveform to the analog pulse waveform, by operation of the second control chip. The method further includes prior to communicating the analog pulse waveform to the respective qubit device, filtering the analog pulse waveform.

In a second example, a quantum computer cluster includes a first quantum computer system including a first qubit device and a second quantum computer system including a second qubit device. The first and second quantum computer systems includes respective quantum processing units housed in distinct cryostats. The quantum computer cluster also includes a global controller communicably coupled to the first and second quantum computer systems and configured to perform operations including obtaining respective local frames from the first and second quantum computer systems; determining respective values of phase compensation for the first and second quantum computer systems based on the respective local frames; transmitting the respective values of the phase compensation to the first and second quantum computer systems; and causing the first and second quantum computer systems to apply phase shifts to phases of control signals communicated to at least one of the first and second qubit devices according to the respective values of the phase compensation received from the global controller.

Implementations of the second example may include one or more of the following features. The first and second quantum computer systems include respective local control systems communicably coupled to the respective quantum processing units and the global controller. Obtaining the respective local frames from the first and second quantum computer systems includes obtaining the respective local frames from the respective local control systems of the first and second quantum computer systems. The respective local frames include a first local frame and a second local frame. The first local frame is indicative to a first relative phase of the first qubit device with respect to a first reference frame of the first quantum computer system, and the second local frame is indicative to a second relative phase of the second qubit device with respective a second reference frame. The first reference frame is distinct from the second reference frame. The first and second reference frames are the same and are obtained from a common reference frame. The first and second local frames are determined by operation of the respective local control systems of the first and second quantum computer systems.

Implementations of the second example may include one or more of the following features. The respective values of the phase compensation include a first value and a second value. The phase shifts include a first shift to a first qubit drive phase of a first qubit drive signal communicated to the first qubit device in the first quantum computer system according to the first value of the phase compensation, and a second shift to a second qubit drive phase of a second qubit drive signal communicated to the second qubit device in the second quantum computer system according to the second value of the phase compensation.

Implementations of the second example may include one or more of the following features. The respective quantum processing units of the first and second quantum computer systems are interconnected via a coherent interlink configured to create entanglement between the first and second qubit devices. The coherent interlink is an optical coherent interlink. The respective local control systems include respective signal conversion units. The first and second qubit devices are interconnected via the respective signal conversion units and the coherent interlink. The coherent interlink is a superconducting coherent interlink including a transmission line. The first and second qubit devices are coupled to the transmission line via a tunable-frequency coupler device.

Implementations of the second example may include one or more of the following features. Each local control system includes a first control chip configured to generate a digital pulse waveform, and a second, distinct control chip configured to condition the digital pulse waveform and generate an analog pulse waveform. Each local control system is configured to receive a respective value of the phase compensation and to apply a phase shift to the digital pulse waveform. The phase-shifted digital pulse waveform is communicated from the first control chip to the second distinct control chip. The second control chip includes an up-sampling module configured to up-sample the digital pulse waveform to increase a sample rate of the digital pulse waveform from a first value to a second value. The first value is in a range of 100-200 mega samples per second (Msps), and the second value is two giga samples per second (Gsps). The up-sampling module is configured to perform an interpolation process. The second control chip includes a pre-compensation module configured to pulse shape the up-sampled digital pulse waveform. The pre-compensation module is configured to account for a transfer function between the local control system and a respective qubit device of a quantum computer system. A coefficient of the pre-compensation module is determined according to a drift in the transfer function. The pre-compensation module is configured to operate at the sample rate of the second value. The second control chip includes a digital-to-analog conversion (DAC) unit configured to convert the conditioned digital pulsed waveform into the analog pulse waveform.

In a third example, a method for conditioning control signals from a local control system to a qubit device of a quantum processing unit in a quantum computer system, includes obtaining a digital pulse waveform; up-sampling the digital pulse waveform; pulse-shaping the up-sampled digital pulse waveform; converting the pulse-shaped digital pulse waveform to an analog pulse waveform; filtering the analog pulse waveform; and communicating the analog pulse waveform to the qubit device in the quantum processing unit of the quantum computer system.

Implementations of the third example may include one or more of the following features. Obtaining the digital pulse waveform includes applying a phase shift to an initial digital pulse waveform. The quantum computer system is a first quantum computer system in a quantum computer cluster. The qubit device is a first qubit device. The first quantum computer system includes a first quantum processing unit, which is housed in a first cryostat and includes the first qubit device. The quantum computer cluster further includes a global controller, and a second quantum computer system. The second quantum computer system includes a second quantum processing unit which is housed in a second, distinct cryostat and includes a second qubit device. Each of the first and second quantum computer systems is communicably connected to the global controller. The phase shift is determined by the global controller based on the respective local frames from the first and second quantum computer systems. The first and second quantum processing units of the first and second quantum computer systems are interconnected via a coherent interlink configured to create entanglement between the first and second qubit devices. The first and second quantum computer systems include respective local control systems communicably coupled to the respective quantum processing units and the global controller. The respective local frames are obtained from the respective local control systems of the first and second quantum computer systems. The digital pulse waveform is generated by operation of the respective local control system of the first quantum computer system.

Implementations of the third example may include one or more of the following features. Up-sampling the digital pulse waveform includes up-sampling the digital pulse waveform to increase a sample rate of the digital pulse waveform from a first value to a second value. The first value is in a range of 100-200 Mega samples per second (Msps), and the second value is two giga samples per second (Gsps). Up-sampling the digital pulse waveform includes up-sampling the digital pulse waveform by performing an interpolation process. Pulse-shaping the up-sampled digital pulse waveform includes applying a pre-compensation filter to the up-sampled digital pulse waveform. The pre-compensation filter is configured to account for a transfer function between the local control system and the qubit device of the quantum computer system. The pre-compensation filter is configured to operate at the sample rate of the second value. In response to a drift in the transfer function being detected, the method further includes re-programming one or more coefficients of the pre-compensation filter.

In a fourth example, a quantum computer system includes a quantum processing unit comprising qubit devices, and a local control system communicably coupled to the quantum processing unit. The control system includes a control chip configured to perform operations including obtaining a digital pulse waveform; up-sampling the digital pulse waveform; pulse-shaping the up-sampled digital pulse waveform; converting the pulse-shaped digital pulse waveform to an analog pulse waveform; filtering the analog pulse waveform; and communicating the analog pulse waveform to a qubit device of the quantum processing unit.

Implementations of the fourth example may include one or more of the following features. The control chip is a first control chip. The local control system comprises a second control chip. The operations include, by operation of the second control chip, applying a phase shift to an initial digital pulse waveform. The quantum computer system is a first quantum computer system in a quantum computer cluster. The quantum processing unit is a first quantum processing unit, and the qubit device is a first qubit device. The first quantum computer system includes the first quantum processing unit which is housed in a first cryostat and includes the first qubit device. The quantum computer cluster further includes a global controller and a second quantum computer system. The second quantum computer system includes a second quantum processing unit which is housed in a second, distinct cryostat and includes a second qubit device. Each of the first and second quantum computer systems is communicably connected to the global controller. The phase shift is determined by the global controller based on the respective local frames from the first and second quantum computer systems. The first and second quantum processing units of the first and second quantum computer systems are interconnected via a coherent interlink configured to create entanglement between the first and second qubit devices. The first and second quantum computer systems include respective local control systems communicably coupled to the respective quantum processing units and the global controller. The respective local frames are obtained from the respective local control systems of the first and second quantum computer systems.

Implementations of the fourth example may include one or more of the following features. Up-sampling the digital pulse waveform includes up-sampling the digital pulse waveform to increase a sample rate of the digital pulse waveform from a first value to a second value. The first value is in a range of 100-200 Mega samples per second (Msps), and the second value is two giga samples per second (Gsps). Up-sampling the digital pulse waveform includes up-sampling the digital pulse waveform by performing an interpolation process. Pulse-shaping the up-sampled digital pulse waveform includes applying a pre-compensation filter to the up-sampled digital pulse waveform. The pre-compensation filter is configured to account for a transfer function between the local control system and the qubit device of the quantum computer system. The pre-compensation filter is configured to operate at the sample rate of the second value. The operations further include in response to a drift in the transfer function being detected, re-programming one or more coefficients of the pre-compensation filter.

In a fifth example, a quantum computer cluster includes a plurality of quantum computer systems coherently interconnected to one another via respective coherent interlinks. Each quantum computer system includes a quantum processing unit. Each quantum processing unit has quantum processor chips including qubit devices. Each qubit device in a subset of the qubit devices of the quantum processing unit includes one or more qubit-qubit connections and one or more interlink connections associated with each qubit devices in the subset. A qubit-qubit connection is configured to communicably couple two or more qubit devices on a quantum processing unit. An interlink connection is configured to couple a first qubit device on a first quantum processing unit housed in a first cryostat with a second qubit device on a second quantum processing unit housed in a second, distinct cryostat via a respective coherent interlink.

Implementations of the fifth example may include one or more of the following features. The coherently interconnected quantum computer systems in the quantum computer cluster form a qubit topology. The qubit topology of the quantum computer cluster is a planar topology. The qubit topology of the quantum computer cluster is a toroidal topology. The qubit topology of the quantum computer cluster is a hypercubic topology. The interlink connection includes a tunable-frequency coupler device, which is configured to be activated or deactivated to enable or disable a respective coupling between a respective qubit device and a respective coherent interlink. The subset of the qubit devices resides on edges of the respective quantum processing unit. The subset of the qubit devices resides on corners of the respective quantum processing unit. One or more of the subset of the qubit devices is not on an edge or a corner of the respective quantum processing unit.

Implementations of the fifth example may include one or more of the following features. A quantum processing unit includes a cap wafer. Qubit devices of the quantum processing unit reside on a device wafer. The cap wafer and the device wafer of the quantum processing unit are arranged such that at least one qubit device of the subset is communicably coupled to a respective coherent interlink via a respective conductive through-hole via in the cap wafer. A quantum processing unit includes a cap wafer. Qubit devices of the quantum processing unit reside on a device wafer. The cap wafer and the device wafer are arranged such that at least one qubit device of the subset is communicably coupled to a respective coherent interlink via a respective conductive through-hole via in the device wafer.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

What is claimed is:

1. A method for executing a quantum computer program in a quantum computer cluster, the quantum computer cluster comprising:
a global controller,
a first quantum computer system comprising a first quantum processing unit housed in a first cryostat and comprising a first qubit device, and
a second quantum computer system comprising a second quantum processing unit housed in a second, distinct cryostat and comprising a second qubit device,
each of the first and second quantum computer systems being communicably connected to the global controller;
the method comprising, by operation of the global controller:
obtaining respective local frames from the first and second quantum computer systems;
determining respective values of phase compensation for the first and second quantum computer systems based on the respective local frames;
transmitting the respective values of the phase compensation to the first and second quantum computer systems; and
causing the first and second quantum computer systems to apply phase shifts to phases of control signals communicated to at least one of the first and second qubit devices according to the respective values of the phase compensation received from the global controller.

2. The method of claim 1, wherein the first and second quantum computer systems comprise respective local control systems communicably coupled to the respective quantum processing units and the global controller, and obtaining the respective local frames from the first and second quantum computer systems comprises obtaining the respective local frames from the respective local control systems of the first and second quantum computer systems.

3. The method of claim 2, wherein obtaining the respective local frames from the first and second quantum computer system comprises:
obtaining a first local frame from the first quantum computer system, the first local frame indicative of a first relative phase of the first qubit device with respect to a first reference frame; and
obtaining a second local frame from the second quantum computer system, the second local frame indicative of a second relative phase of the second qubit device with respective a second reference frame.

4. The method of claim 3, wherein the first reference frame is distinct from the second reference frame.

5. The method of claim 3, wherein the first and second reference frames are the same and are obtained from a common reference frame.

6. The method of claim 3, wherein the first and second local frames are determined by operation of the respective local control systems of the first and second quantum computer systems.

7. The method of claim 2, wherein applying the phase shifts comprises:
by operation of the respective local control systems:
shifting a first qubit drive phase of a first qubit drive signal communicated to the first qubit device in the first quantum computer system according to a first value of the phase compensation; and
shifting a second qubit drive phase of a second qubit drive signal communicated to the second qubit device in the second quantum computer system according to a second value of the phase compensation.

8. The method of claim 1, wherein the respective quantum processing units of the first and second quantum computer systems are interconnected via a coherent interlink configured to create entanglement between the first and second qubit devices.

9. The method of claim 8, wherein the first and second quantum computer systems comprise respective local control systems communicably coupled to the respective quantum processing units and the global controller, the coherent interlink is an optical coherent interlink, the respective local control systems comprise respective signal conversion units, and the first and second qubit devices are interconnected via the respective signal conversion units and the coherent interlink.

10. The method of claim 8, wherein the coherent interlink is a superconducting coherent interlink comprising a transmission line, and the first and second qubit devices are coupled to the transmission line via respective tunable-frequency coupler devices.

11. The method of claim 1, comprising communicating the phase shifted control signals to respective qubit devices, wherein communicating the phase shifted control signals comprises:
obtaining a digital pulse waveform;
converting the digital pulse waveform to an analog pulse waveform; and
communicating the analog pulse waveform to the respective qubit device.

12. The method of claim 11, wherein obtaining the digital pulse waveform comprises:
applying a phase shift to an initial digital pulse waveform.

13. The method of claim 11, wherein obtaining the digital pulse waveform comprises:
generating the digital pulse waveform by operation of a first control chip; and
communicating the digital pulse waveform from the first chip to a second, distinct control chip.

14. The method of claim 13, comprising:
reducing a bandwidth between the first and second control chips.

15. The method of claim 14, wherein reducing the bandwidth between the first and second control chips comprises:
up-sampling the digital pulse waveform to increase a sample rate of the digital pulse waveform from a first value to a second value.

16. The method of claim 15, wherein the first value is in a range of 100-200 Mega samples per second (Msps), and the second value is two giga samples per second (Gsps).

17. The method of claim 15, wherein up-sampling the digital pulse waveform comprises:
up-sampling the digital pulse waveform by performing an interpolation process.

18. The method of claim 15, comprising:
after up-sampling the digital pulse waveform, pulse-shaping the up-sampled digital pulse waveform.

19. The method of claim 18, wherein pulse-shaping the up-sampled digital pulse waveform comprises applying a pre-compensation filter to the up-sampled digital pulse waveform, and the pre-compensation filter is configured to account for a transfer function between the local control system and a respective qubit device of a quantum computer system.

20. The method of claim 19, wherein the pre-compensation filter is configured to operate at the sample rate of the second value.

21. The method of claim 19, comprising:
in response to a drift in the transfer function being detected, re-programming one or more coefficients of the pre-compensation filter.

22. The method of claim 13, wherein converting the digital pulse waveform to the analog pulse waveform comprises converting the digital pulse waveform to the analog pulse waveform, by operation of the second control chip.

23. The method of claim 11,
prior to communicating the analog pulse waveform to the respective qubit device, filtering the analog pulse waveform.

24. The method of claim 11,
prior to communicating the analog pulse waveform to the respective qubit device, applying a pre-compensation filter to the analog pulse waveform, wherein the pre-compensation filter is an analog pre-compensation filter, and the pre-compensation filter is configured to account for a transfer function between the local control system and a respective qubit device of a quantum computer system.

25. A quantum computer cluster comprising:
a first quantum computer system comprising a first quantum processing unit housed in a first cryostat and comprising a first qubit device;
a second quantum computer system comprising a second quantum processing unit housed in a second, distinct cryostat and comprising a second qubit device; and
a global controller communicably coupled to the first and second quantum computer systems and configured to perform operations comprising:
obtaining respective local frames from the first and second quantum computer systems;
determining respective values of phase compensation for the first and second quantum computer systems based on the respective local frames;
transmitting the respective values of the phase compensation to the first and second quantum computer systems; and
causing the first and second quantum computer systems to apply phase shifts to phases of control signals communicated to at least one of the first and second qubit devices according to the respective values of the phase compensation received from the global controller.

26. The quantum computer cluster of claim 25, wherein the first and second quantum computer systems comprise respective local control systems communicably coupled to the respective quantum processing units and the global controller, and obtaining the respective local frames from the first and second quantum computer systems comprises obtaining the respective local frames from the respective local control systems of the first and second quantum computer systems.

27. The quantum computer cluster of claim 26, wherein the respective local frames comprise a first local frame and a second local frame, the first local frame is indicative of a first relative phase of the first qubit device with respect to a first reference frame of the first quantum computer system, and the second local frame is indicative of a second relative phase of the second qubit device with respective a second reference frame.

28. The quantum computer cluster of claim 27, wherein the first reference frame is distinct from the second reference frame.

29. The quantum computer cluster of claim 27, wherein the first and second reference frames are the same and are obtained from a common reference frame.

30. The quantum computer cluster of claim 27, wherein the first and second local frames are determined by operation of the respective local control systems of the first and second quantum computer systems.

31. The quantum computer cluster of claim 26, wherein the respective values of the phase compensation comprise a first value and a second value, and applying the phase shifts comprises:
applying a first shift to a first qubit drive phase of a first qubit drive signal communicated to the first qubit device in the first quantum computer system according to the first value of the phase compensation, and
applying a second shift to a second qubit drive phase of a second qubit drive signal communicated to the second qubit device in the second quantum computer system according to the second value of the phase compensation.

32. The quantum computer cluster of claim 25, wherein the respective quantum processing units of the first and second quantum computer systems are interconnected via a coherent interlink configured to create entanglement between the first and second qubit devices.

33. The quantum computer cluster of claim 32, wherein the first and second quantum computer systems comprise respective local control systems communicably coupled to the respective quantum processing units and the global controller, the coherent interlink is an optical coherent interlink, the respective local control systems comprise respective signal conversion units, and the first and second qubit devices are interconnected via the respective signal conversion units and the coherent interlink.

34. The quantum computer cluster of claim 32, wherein the coherent interlink is a superconducting coherent interlink comprising a transmission line, and the first and second qubit devices are coupled to the transmission line via respective tunable-frequency coupler devices.

35. The quantum computer cluster of claim 25, wherein the first and second quantum computer systems comprise respective local control systems communicably coupled to the respective quantum processing units and the global controller, each local control system comprises a first control chip configured to generate a digital pulse waveform, and a second, distinct control chip configured to condition the digital pulse waveform and convert the digital pulse waveform to an analog pulse waveform.

36. The quantum computer cluster of claim 35, wherein each local control system is configured to receive a respective value of the phase compensation and to apply a phase shift to the digital pulse waveform.

37. The quantum computer cluster of claim 36, wherein the phase-shifted digital pulse waveform is communicated from the first control chip to the second distinct control chip.

38. The quantum computer cluster of claim 35, wherein the second control chip comprises an up-sampling module configured to up-sample the digital pulse waveform to increase a sample rate of the digital pulse waveform from a first value to a second value.

39. The quantum computer cluster of claim 38, wherein the first value is in a range of 100-200 mega samples per second (Msps), and the second value is two giga samples per second (Gsps).

40. The quantum computer cluster of claim 38, wherein the up-sampling module is configured to perform an interpolation process.

41. The quantum computer cluster of claim 38, wherein the second control chip comprises a pre-compensation module configured to pulse shape the up-sampled digital pulse waveform.

42. The quantum computer cluster of claim 41, wherein the pre-compensation module is configured to account for a transfer function between the local control system and a respective qubit device of a quantum computer system.

43. The quantum computer cluster of claim 42, wherein a coefficient of the pre-compensation module is determined according to a drift in the transfer function.

44. The quantum computer cluster of claim 41, wherein the pre-compensation module is configured to operate at the sample rate of the second value.

45. The quantum computer cluster of claim 38, wherein the second control chip comprises a digital-to-analog conversion (DAC) unit configured to convert the conditioned digital pulsed waveform into the analog pulse waveform.

46. The quantum computer cluster of claim 25, wherein the first and second quantum computer systems comprise respective local control systems communicably coupled to the respective quantum processing units and the global controller, each local control system comprises a first control chip configured to output an analog pulse waveform based on a digital pulse waveform, and a second, distinct control chip configured to condition the analog pulse waveform.

47. The quantum computer cluster of claim 46, wherein each local control system is configured to receive a respective value of the phase compensation and to apply a phase shift to the digital pulse waveform.

48. The quantum computer cluster of claim 47, wherein the phase-shifted digital pulse waveform is converted to the analog pulse waveform, by operation of the first control chip.

49. The quantum computer cluster of claim 46, wherein the second control chip include an analog pre-compensation filter, and the pre-compensation filter is configured to account for a transfer function between the local control system and a respective qubit device of a quantum computer system.

50. The quantum computer cluster of claim 46, wherein the pre-compensation filter is configured to operate at the sample rate in a range of 100-200 Msps.

51. A method for conditioning control signals from a local control system to a qubit device of a quantum processing unit in a quantum computer system, the method comprising:
obtaining a digital pulse waveform;
up-sampling the digital pulse waveform;
pulse-shaping the up-sampled digital pulse waveform;
converting the pulse-shaped digital pulse waveform to an analog pulse waveform;
filtering the analog pulse waveform; and
communicating the analog pulse waveform to the qubit device in the quantum processing unit of the quantum computer system.

52. The method of claim 51, wherein obtaining the digital pulse waveform comprises:
applying a phase shift to an initial digital pulse waveform.

53. The method of claim 52, wherein the quantum computer system is a first quantum computer system in a quantum computer cluster, the qubit device is a first qubit device, the first quantum computer system comprises a first quantum processing unit housed in a first cryostat and comprising a first qubit device, the quantum computer cluster comprises a global controller and a second quantum computer system comprising a second quantum processing unit housed in a second, distinct cryostat and comprising a second qubit device, each of the first and second quantum computer systems is communicably connected to the global controller, and the phase shift is determined by the global controller based on the respective local frames from the first and second quantum computer systems.

54. The method of claim 53, wherein the first and second quantum processing units of the first and second quantum computer systems are interconnected via a coherent interlink configured to create entanglement between the first and second qubit devices.

55. The method of claim 53, wherein the first and second quantum computer systems comprise respective local control systems communicably coupled to the respective quantum processing units and the global controller, and the respective local frames are obtained from the respective local control systems of the first and second quantum computer systems.

56. The method of claim 55, wherein the digital pulse waveform is generated by operation of the respective local control system of the first quantum computer system.

57. The method of claim 51, wherein up-sampling the digital pulse waveform comprises:
up-sampling the digital pulse waveform to increase a sample rate of the digital pulse waveform from a first value to a second value.

58. The method of claim 57, wherein the first value is in a range of 100-200 Mega samples per second (Msps), and the second value is two giga samples per second (Gsps).

59. The method of claim 57, wherein up-sampling the digital pulse waveform comprises:
up-sampling the digital pulse waveform by performing an interpolation process.

60. The method of claim 57, wherein pulse-shaping the up-sampled digital pulse waveform comprises:
applying a pre-compensation filter to the up-sampled digital pulse waveform, and the pre-compensation filter is configured to account for a transfer function between the local control system and the qubit device of the quantum computer system.

61. The method of claim 60, wherein the pre-compensation filter is configured to operate at the sample rate of the second value.

62. The method of claim 60, comprising:
in response to a drift in the transfer function being detected, re-programming one or more coefficients of the pre-compensation filter.

63. The method of claim 51, wherein the local control system comprises a first control chip and a second control chip, and obtaining the digital pulse waveform comprises:
obtaining the digital pulse waveform from the first control chip by the second control chip, and the method comprises:
by operation of the second control chip,
up-sampling the digital pulse waveform;
pulse-shaping the up-sampled digital pulse waveform;
converting the pulse-shaped digital pulse waveform to an analog pulse waveform;
filtering the analog pulse waveform; and
communicating the analog pulse waveform to the qubit device in the quantum processing unit of the quantum computer system.

64. A quantum computer system comprising:
a quantum processing unit comprising qubit devices, and
a local control system communicably coupled to the quantum processing unit, the control system comprising a control chip configured to perform operations comprising:
obtaining a digital pulse waveform;
up-sampling the digital pulse waveform;
pulse-shaping the up-sampled digital pulse waveform;
converting the pulse-shaped digital pulse waveform to an analog pulse waveform;
filtering the analog pulse waveform; and
communicating the analog pulse waveform to a qubit device of the quantum processing unit.

65. The system of claim 64, wherein the control chip is a first control chip, the local control system comprises a second control chip, and the operations comprise:
by operation of the second control chip, applying a phase shift to an initial digital pulse waveform.

66. The system of claim 65, wherein the quantum computer system is a first quantum computer system in a quantum computer cluster, the first quantum computer system comprises a first quantum processing unit housed in a first cryostat and comprising a first qubit device, the quantum computer cluster comprises a global controller and a second quantum computer system comprising a second quantum processing unit housed in a second, distinct cryostat and comprising a second qubit device, each of the first and second quantum computer systems is communicably connected to the global controller, and the phase shift is determined by the global controller based on the respective local frames from the first and second quantum computer systems.

67. The system of claim 66, wherein the first and second quantum processing units of the first and second quantum computer systems are interconnected via a coherent interlink configured to create entanglement between the first and second qubit devices.

68. The system of claim 66, wherein the first and second quantum computer systems comprise respective local control systems communicably coupled to the respective quantum processing units and the global controller, and the respective local frames are obtained from the respective local control systems of the first and second quantum computer systems.

69. The system of claim 65, wherein up-sampling the digital pulse waveform comprises:
up-sampling the digital pulse waveform to increase a sample rate of the digital pulse waveform from a first value to a second value.

70. The system of claim 69, wherein the first value is in a range of 100-200 Mega samples per second (Msps), and the second value is two giga samples per second (Gsps).

71. The system of claim 69, wherein up-sampling the digital pulse waveform comprises:
up-sampling the digital pulse waveform by performing an interpolation process.

72. The system of claim 69, wherein pulse-shaping the up-sampled digital pulse waveform comprises:
applying a pre-compensation filter to the up-sampled digital pulse waveform, and the pre-compensation filter is configured to account for a transfer function between the local control system and the qubit device of the quantum computer system.

73. The system of claim 72, wherein the pre-compensation filter is configured to operate at the sample rate of the second value.

74. The system of claim 72, comprising:
in response to a drift in the transfer function being detected, re-programming one or more coefficients of the pre-compensation filter.

75. A quantum computer cluster comprising:
a plurality of quantum computer systems coherently interconnected to one another via respective coherent interlinks, each quantum computer system comprising a quantum processing unit, the quantum processing unit having quantum processor chips comprising qubit devices, and each qubit device in a subset of the qubit devices comprising one or more qubit-qubit connections and one or more interlink connections associated with each qubit device in the subset,
wherein a qubit-qubit connection is configured to couple two or more qubit devices on the same quantum processor chip, and an interlink connection is configured to couple a first qubit device on a first quantum processing unit housed in a first cryostat with a second qubit device on a second quantum processing unit housed in a second, distinct cryostat via a respective coherent interlink.

76. The quantum computer cluster of claim 75, wherein the coherently interconnected quantum computer systems in the quantum computer cluster form a qubit topology.

77. The quantum computer cluster of claim 76, wherein the qubit topology of the quantum computer cluster is a planar topology.

78. The quantum computer cluster of claim 76, wherein the qubit topology of the quantum computer cluster is a toroidal topology.

79. The quantum computer cluster of claim 76, wherein the qubit topology of the quantum computer cluster is a hypercubic topology.

80. The quantum computer cluster of claim 75, wherein the interlink connection comprises a tunable-frequency coupler device configured to be activated or deactivated to enable or disable a respective coupling between a respective qubit device and a respective coherent interlink.

81. The quantum computer cluster of claim 75, wherein the subset of the qubit devices resides on edges of the respective quantum processing unit.

82. The quantum computer cluster of claim 75, wherein the subset of the qubit devices resides on corners of the respective quantum processing unit.

83. The quantum computer cluster of claim 75, wherein a quantum processing unit comprises a cap wafer, qubit devices of the quantum processing unit reside on a device wafer, the cap wafer and the device wafer are arranged such that at least one qubit device of the subset is communicably coupled to a respective coherent interlink via a respective conductive through-hole via in the cap wafer.

84. The quantum computer cluster of claim 75, wherein a quantum processing unit comprises a cap wafer, qubit devices of the quantum processing unit reside on a device wafer, the cap wafer and the device wafer are arranged such that at least one qubit device of the subset is communicably coupled to a respective coherent interlink via a respective conductive through-hole via in the device wafer.
